(19) United States
(12) Patent Application Publication
(10) Pub. No.: US 2016/0334778 A1
(43) Pub. Date: Nov. 17, 2016

(54) METHOD AND SYSTEM FOR INTEGRATED MANUFACTURING PRODUCTION QUALITY INSPECTIONS

(71) Applicant: InspectionXpert Corporation, Apex, NC (US)

(72) Inventor: Jeffery Neal Cope, Apex, NC (US)

(73) Assignee: InspectionXpert Corporation, Apex, NC (US)

(21) Appl. No.: 15/154,611

(22) Filed: May 13, 2016

Related U.S. Application Data
(60) Provisional application No. 62/161,060, filed on May 13, 2015.

(51) Int. Cl. G05B 19/401; G01B 21/00

(52) U.S. Cl. CPC G05B 19/401; G01B 21/00; G06Q 50/04

(57) ABSTRACT

A system and computer-implemented method comprising receiving at a memory device a manufacturing process plan having a plurality of operating steps including data from a bill of specification including manufacturing process step requirements for a manufactured product and data from a bill of characteristics including dimensions and tolerances for the manufactured product where the system or method extract data via a processor executing instructions from both the bill of specification and the bill of characteristics relating to inspection of the manufactured product and define a job to produce the manufactured product wherein the job includes assigning an identification number, specifying the product to be manufactured, identifying the quantity to be made, and identifying the number of manufactured products to be inspected. The system or method further group manufacturing dimensions extracted from the bill of characteristics by operating step in manufacturing process plan and populate a browser-based inspection screen to be viewed by an operator including inspection requirements specific to the operating step to be performed by the operator.

### CROSS-REFERENCE TO RELATED APPLICATION(S)

This application claims priority to U.S. Provisional Patent Application No. 62/161,060, entitled “QualityXpert,” filed on May 13, 2015, which is assigned to the current assignee hereof and is incorporated herein by reference in its entirety.

### FIELD OF THE DISCLOSURE

The present invention relates generally to information systems. More specifically, the present invention is a computer implemented method of organizing, presenting and executing an inspection plan for the purpose of planning, storing, displaying, executing and analyzing results of quality inspections for manufactured goods and items located, installed or operating in the field.

### BACKGROUND

Inspections of items such as manufacturing components, products, machines, and technical inspections of items in the field such as buildings, homes, land, structures, computer devices, all require active, repeated and real time reference to a number of documents. Inspections center around and require a drawing or an image that illustrates or shows a picture of the accurate and final specifications and also require related information contained in various documents, physical and/or electronic. These documents include plans, models, diagrams, maps, specifications lists, dimensional tolerances, feature and detail characteristics, work instructions, product manuals and other associated documentation which are all required for an inspection because they contain the facts, requirements and details of the planned and designed end product or correct and true depiction of the final and current state. These documents are often in different physical (paper) and/or electronic forms (programs like Microsoft Word, Excel and/or Adobe PDF) and are usually not connected or integrated in a manner that allows easy and immediate reference. In the cases wherein such inspection documentation is in electronic form and the user wants to use a computer, the user has to have specific and often expensive and complex additional software products to receive the documents electronically to download them to the memory device on the computer and use them.

The drawbacks to this current process of collecting, organizing and utilizing documents for inspections are significant and in most cases a hindrance to faster, easier and more accurate inspections.

One of the primary drawbacks includes the expense and labor associated with the most common situation which is the gathering, organizing and using paper documents. This lack of organization, the cost and time required for transmission and communication of the documents and information, and the labor intensive and error prone manual handling of documents and recording inspection results is one of the key contributors to errors during inspections.

If one wants to use software, the drawbacks include having to purchase and maintain the correct versions of the enabling software programs required to open and use all the inspection documentation, learning how to use the features and capabilities of each program at a fairly high degree of competency and the requirement of using all the documents in the correct sequence. For example, to view many CAD generating drawings or 3D models, expensive specialized software must be purchased and mastered. Other document formats require additional software to be downloaded and used on each device in order to use the documents such as Adobe Acrobat to view a .PDF file type.

Together, the software license costs and mastery of all the programs can be significant barrier to faster, easier and more accurate inspections. Being able to utilize a simple, browser based application that does not require all these software programs to receive, read and utilize the information required for an inspection solves this problem makes it easier for inspectors to perform inspections.

Another drawback of the current method of collecting and utilizing documents for inspections is the lack of integration and coordination between the paper and software products and the frequent discrepancies between the document content that lead to inaccurate and less useful inspections. For example, once the all the software products have been purchased, mastered and downloaded to a device the inspector must then simultaneously open and refer to documents, such as; a bill of materials; dimensional and characteristic inspection plans; drawings, maps, and illustrations; work instructions and manuals; non-conformance procedures, notes, and other documents. In addition to the physical challenges of jumping between the different programs, files and documents, if specifications in the documents are not in sequence errors and problems can often arise.

A typical occurrence is the different ordering of the details and features which have been called out on the drawing (called “Ballooned”) and ordering of the actual inspection plan itself. These discrepancies require the inspector to manually find each detail on the drawing and cross reference it on the inspection plan. If more information is needed, the other documents must be referenced and searched taking more time and introducing additional points of errors.

The current methods and tools for inspections are potential security risks to secret, export controlled, intellectual property and other confidential and proprietary information. This risk arises when owners of the information distribute physical documents or software files needed for inspections that can be copied, shared or mishandled either intentionally or intentionally. For example, if the plans, specifications and other information required for a supplier to manufacture a critical part for a jet engine are transmitted as paper documents or software files, these can be easily compromised because the recipient of the documents has possession of the source information engine that can be quickly copied, downloaded or re-sent to an unauthorized 3rd party.

This risk is substantially reduced, if not eliminated by this invention because all the information required for the inspection is accessed and used in real time via the common web browsers, and can include multiple levels of upfront and ongoing/online security checks. This method only provides the HTML based images of the information in the browser, not any of the source documents, and only the limited information required for the specific inspection being requested at that time. When the inspection is complete, all the information provided in the browser is deleted. An additional security feature is the ability to identify, monitor and track who, which device and for how long each user accessed each specific inspection plan. Together, these methods increase the control and security related to inspections that include sensitive information that must be handled as securely as possible.

Another drawback and operationally fundamental weakness of the current method of utilizing information and performing inspections is the lack of real time visibility. Today, many inspections occur at one time and the analysis of the results occurs at a later time. While most manual inspections include some system for tracking inspection results all these measurements tend to be complied and reviewed after the fact, limiting the utility of many inspections. One of the main contributors to this problem is the number of paper documents or the PC workstation required to handle the various programs required to read all the electronic documents. Without the use of this invention that provides an integrated and real time application that can be securely used on a low cost web browser based device like a tablet right at the point of manufacturing, most inspections are largely limited to end of line or at designated locations in-line, or if in the field limited checklists.

With the present invention in use, this problem is solved because inspectors can use lower cost and highly portable tablets across the manufacturing floor and in the field, with all the documents required in one application, and most importantly, with the measurements being charted, measured and communicated in real time. This results in major benefits including;
Higher flexibility in focusing inspections on specific details and being able to quickly transmit the inspection plan URL link to an inspector anywhere in the world, at any time,
Faster and more detailed collection of inspections results through hand held tablets right at the point of manufacturer or at field locations, the physical characteristics of which (location, access, and environmental conditions) may have made a traditional detailed inspection difficult if not impossible under current methods.
Real time charting and non-conformance alerts notifying both the user and others in the communications directory of variances to specifications, trends and other inspection information that does not conform to the required state.
The ability to now gather and aggregate inspection data from multiple sources focused on a single manufacturing process, part or field item to spot trends and deviations common across all inspectors.
The ability to identify problems and perform root cause analysis much more quickly with more effective and timely corrective action.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein.

FIG. 1 is an illustration layout of an inspection plan according to an embodiment of the present invention.

FIG. 2 is an illustration of a sequenced list of inspection characteristics according to an embodiment of the present invention.

FIG. 3 is an illustration of an integrated inspection plan including 2D inspection drawing with sequence numbers labeled (with balloon callouts) on each inspection annotation according to an embodiment of the present invention

FIG. 4 is an illustration of an integrated inspection plan including 3D inspection model with sequence numbers labeled (with balloon callouts) on each inspection annotation according to an embodiment of the present invention.

FIG. 5 is an illustration of an integrated inspection plan including 2D inspection drawing with sequence numbers labeled (with balloon callouts) on each inspection annotation according to another embodiment of the present invention.

FIG. 6 is an illustration of an embodiment of an integrated inspection plan including 3D inspection model with sequence numbers labeled (with balloon callouts) on each inspection annotation according to another embodiment of the present invention.

FIG. 7 is an illustration of a list of available quality reports including inspection results and various non-conformance reports according to an embodiment of the present invention.

FIG. 8 is an illustration of an inspection report with user interface elements for sending a link to the inspection report to a customer, co-worker, partner, supplier or auditor according to an embodiment of the present invention.

FIG. 9 is an illustration of an inspection report as being seen by a customer, co-worker, partner, supplier or auditor according to an embodiment of the present invention.

FIG. 10 is an illustration of a list of reports as being seen by a customer, co-worker, partner, supplier or auditor according to an embodiment of the present invention.

FIG. 11 is an illustration of a sequenced list of inspection characteristics with user interface elements for the user to enter inspection frequency for each inspection characteristic according to an embodiment of the present invention.

FIG. 12 is an illustration of a job setup screen with user interface elements for the user to enter job details such as job number, job owner, job due date, job status and parts to be made and/or inspected for the job according to an embodiment of the present invention.

FIG. 13 is an illustration of a list of inspection jobs with user interface elements for the user to filter the jobs shown according to an embodiment of the present invention.

FIG. 14 is an illustration of a measurement entry form showing inspection traceability information including who recorded the measurement, when the measurement was recorded and what device was used to take the measurement reading according to an embodiment of the present invention.

FIG. 15 is an illustration of a measurement entry form showing non-conforming measurement information including the cause of the non-conformance, a comment about the cause of the non-conformance and the action taken to correct the nonconformance according to an embodiment of the present invention.

FIG. 16 is a flow chart illustrating a method of establishing an integrated browser-based inspection plan via a browser-based inspection screen according to an embodiment of the present invention.

FIG. 17 is flow chart illustrating a method of operating an integrated browser-based inspection plan via a browser-based inspection screen according to an embodiment of the present invention.

FIG. 18 is a block diagram illustrating an embodiment of servers, personal computers, mobile devices, or other computing system architecture that may be used to perform the methods and implement the creation and use of embodiments of the integrated browser-based inspection system described herein.

### DETAILED DESCRIPTION OF THE DRAWINGS

All illustrations of the drawings are for the purpose of describing selected versions of the present invention and are not intended to limit the scope of the present invention.

The present invention is a computer implemented method of organizing, presenting and delivering a browser based inspection plan for manufacturing items and field inspections, that includes a 2D part or assembly inspection drawing and/or 3D part or assembly inspection model with, a sequenced list of inspection requirements including the inspection characteristics (e.g. dimensions, tolerances, notes, etc. . . . ) with their required values, work instructions, and other electronic documentation which is all integrated and associated within a browser based program.

The position and size of the electronic 2 dimensional drawing or 3 dimensional model is determined by a mathematical algorithm that automatically positions the 2D drawing or 3D model to display to the user the most appropriate area on the 2D drawing or 3D model based on the inspection characteristic chosen for inspection. This is done based the location of the inspection characteristic on the 2D drawing or 3D model based on some combination of the inspection characteristic's corresponding annotation's display view, page, x, y, z coordinates, text height, balloon text height and browser dimensions. In an example embodiment, the 2D and 3D drawings may be derived from computer-aided design (CAD) drawings that include a blueprint of design for a manufactured item. Such a 2D or 3D drawing may be delivered as part of a technical data package relating to the engineering or design requirements of a manufactured item. Additional data or information may be received as part of a technical data package for a manufactured item including a bill of characteristics, a bill of specification, a bill of materials and standards required for physical characteristics of the item being manufactured. It is appreciated that physical manufacture of items may be of a variety of sorts having varying levels of physical requirements for their intended purposes. For example, manufactured items to be used in some settings, such as medical or transportation settings may involve strict safety or durability requirements engineered into manufactured parts. Other consumer or manufactured product items may not require as stringent a set of inspection standards to be met.

Much of the technical data package may be voluminous and inefficient to cross reference for each of the several operating steps to manufacture an item. In an aspect, the integrated browser-based inspection system provides for a manufacturing process plan involving several operating steps to produce a manufactured item. In another aspect, the integrated browser-based inspection system provides for graphical guidance across the breadth of characteristics, process specifications, materials for the operating steps during the course of manufacture. In a particular aspect, the integrated browser-based inspection system provides for graphical guidance relating to conducting inspections across the various physical characteristics, process specifications, or materials relevant to particular operating steps within the manufacturing process plan. An example of the graphical guidance relating to conducting inspections of production of a manufactured item includes balloon callouts on to a 2D or 3D drawing. In another example embodiment, a menu for selecting an inspection method may be displayed indicating particular measurements to be taken and data to be entered for the inspection instance. This may include inputting a measurement, inputting a machine or measurement tool used to conduct the measurement, inputting the machine that performed the operating step of the manufacturing process plan subject to inspection, data relating to the operator, indication of whether a part detail or process specification meet conformance with standards and tolerances set for the manufacture of the part, and the like. In an instance of non-conformance of an inspection during or after an operating step, additional traceability detail for a non-conformance alert report may be gathered by presentation of a screen to the operator. Addition guided inspection aspects include presentation of standards, inspection characteristics, and specification details drawn to a particular operating step within the determined manufacturing process plan and may include inspection instructions for measurements and instructions for manufacture at the operating step. Additional guidance is provided by the browser-based inspection system in accordance with embodiments disclosed herein.

In one aspect, balloon callouts are applied to particular locations of the integrated 2D or 3D drawing relating to locations relevant to an operating step of an overall manufacturing process plan developed to produce a manufactured item in some example embodiments. The balloon callouts may relate and cross-reference a set of dimensions, tolerances, geometric requirements, or other physical characteristics of the highlighted aspect of an item to be manufactured. These items may be derived from a technical data package relating to engineering or design requirements for the manufactured item in the overall manufacturing process plan utilized by the integrated browser-based inspection system of the present disclosure. In an aspect, the determined dimensions, tolerances, geometric requirements and other physical characteristics may form a basis for some of the inspection characteristics for inspections via the integrated browser-based inspection system.

In another aspect, the balloon callouts may relate to detailed manufacturing process step specifications to perform a detailed manufacturing process step associated with particular locations of the integrated 2D or 3D drawing. Similarly, the balloon callouts may relate and cross-reference to a set of process parameters or qualities to be achieved at a detailed manufacturing process step. Such detailed process parameters may include qualities of a resulting product at the juncture of the operating step of the overall manufacturing process plan including qualities such as hardness, abrasiveness, polish, sharpness, color, conductivity, coating thickness, etching level, and the like. Additional detailed process parameters include time, temperature, energy level, speed, angle, concentration levels, and other factors for applied treatments including heat, chemical, electro-induction, drying, lubrication, feed rates, cutting speeds, spindle speeds, among others treatment options for each detailed manufacturing process step conducted as part of an overall manufacturing process plan to produce (and inspect) parts for manufacture.

The browser-based inspection system of the present disclosure navigates the user to each referenced geographic area/location on the drawing or image that corresponds with each item in the inspection characteristic checklist. The combination of ballooned or annotated of 2D and 3D images with related inspection documentation is rendered in the computer browser (internet or intranet/WAN). The field of vision is detected and adjusted for the electronic 2 dimensional drawing or 3 dimensional model relative to the location and size of the item being inspected (the annotation) and relevant portions of the drawing are displayed with a browser-based inspection screen in the system of the present disclosure.

Browser-based refers to a virtualized or cloud based inspection system executing code instructions in parts or entirely at remote servers or locally based processors. The code instructions and databases for the browser-based inspection system of the present disclosure may be accessed from anywhere with the browser-based system via screens made available at terminals or on various computing system. The browser-based inspection system of the present disclosure may be accessible via web-based browsers, intranet access, or other networked connectivity understood to provide for a screen or screens to be made available to manufacturing operators, managers, customers and other users to access the virtualized or cloud based resources. In one example embodiment, a message queue or enterprise bus may provide access screens to users of the browser-based inspection system of the present disclosure. The virtualized, browser-based inspection system of the present disclosure thus provides for synchronization of data and permutations to the manufacturing inspection process to all users. Further it is understood that security measures may be utilized to protect the virtualized function of the browser-based inspection system of the present disclosure and access via any given browser may be limited or controlled as to what is revealed to a user or as to how the larger browser-based inspection system may be interfaced with or altered.

The inspection sequence and actions are directed in a specific user configurable workflow, with related electronic documents such as work instructions, pictures that support the accuracy and effectiveness of the inspection. The workflow may relate to a series of operating steps that comprise an overall manufacturing process plan to produce a part for manufacture in some embodiments. It is understood that the operating steps of an overall manufacturing process plan may be performed in a sequence, in parallel, or in any reasonable order to achieve the requested engineering specifications of a manufactured part or system. The user inputs are dynamically compared to the specified dimensions, instructions, requirements and other instructions of the of the inspection plan. The user inputs are automatically evaluated, with graphical and text based feedback and instructions. The user inputs are automatically communicated to the end user and other parties (via the internet or by other communication methods understood in the art). The variance to the specific inspection requirements trigger automatic non-conformance messages that require specific responses from the user and can trigger specified actions by 3rd parties connected to the inspection via the internet, on a real time basis.

The browser-based inspection system of the present disclosure sends a link to quality inspection report or other quality report to a customer, co-worker, partner, supplier or auditor in some embodiments. The browser-based inspection system of the present disclosure also lists previously shared quality inspection reports and/or other quality reports to a customer, co-worker, partner, supplier or auditor in other embodiments. In some embodiments of the present invention, a system and/or method may include accessing inspection plan software on a remote server via a local fixed and wireless area network, LAN, or a wide area network, WAN (i.e. the internet).

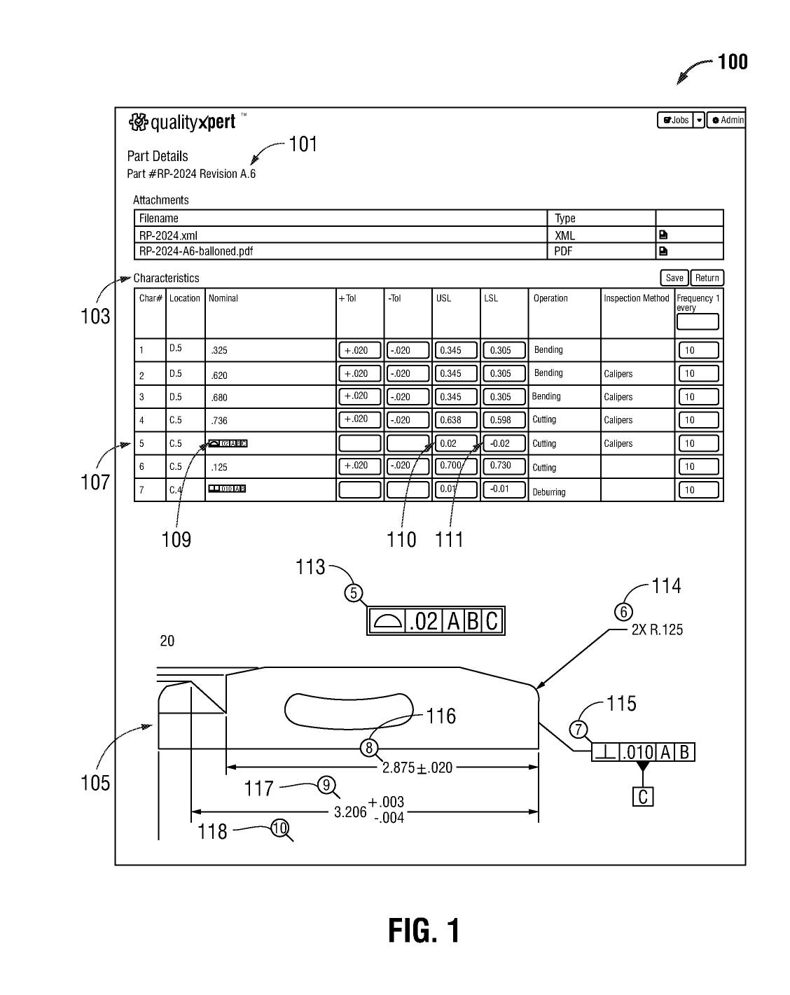

FIG. 1 shows a graphical user interface 100 illustrating an example embodiment of a browser-based inspection system for manufacturing items and conducting field inspections according to an aspect of the present invention. The browser-based inspection system according to embodiments of the present disclosure is a graphically driven system operating as a set of code instructions executed by one or more processors. The executable code instructions may be in software, firmware, or some combination of the same. It is understood that the executable code instructions may be executed in a distributed way in that portions may be executed on one or more systems and databases or may be executed in a virtualized way on remote server systems or the like. The browser-based inspection system of the present disclosure may be networked such that some portions operate at operating stations within a manufacturing facility or among several manufacturing facilities. Further, the browser-based inspection system may report to a centralized database the information relating to the inspection of ongoing manufacturing jobs and processes including a centralized aggregation of non-conforming inspections for review by plant managers or inspection engineers to monitor manufacturing activities. In addition, manufacture of complicated systems may include use of browser-based inspection systems for each portion or component being manufactured as well as for manufacture or assembly of the entire manufactured system such that the browser-based inspection system specific to particular jobs may also communicate or integrate with other jobs relating to the overall manufactured system.

At 101, the browser-based inspection system displays information describing a part number and a revision number. Additional identifying details may be provided on a graphical user interface including a job designation. Job designation may include information including a job identification number unique to the job, specification of the part to be made, specification of a quantity to be made, part revisions, customer or division ordering a part, and inspection levels or inspection frequency in some embodiments of the present disclosure.

As described above, when ordering manufacture of a manufactured item or part, a technical data package is received from part designers including in various embodiments a blueprint of design including CAD drawings, a bill of characteristics, a bill of specification, and a bill of materials. From this information, manufacturing process management may create and input an overall manufacturing process plan including a series of operational steps to manufacture a part of a system. The substantial amount of information from a technical data package or accessed to create the overall manufacturing process plan may also include numerous engineering requirements or standards for dimension, tolerances, geometric design, materials properties, and manufacturing process step requirements to achieve a manufactured part characteristic or quality such as hardness, abrasiveness, polish, sharpness, conductivity, color, coating, etching, layering levels, or the like. Upon receiving the technical data package for a part to be manufactured, the present disclosure contemplates using inspection characteristic identification and extraction software to extract characteristics relevant to portions of the manufactured product, materials to be used, and process specification standards to be used in manufacturing the product. This information is extracted and put into lists or tables for quick cross-reference by the operators for the plurality of operating steps. Since the overall manufacturing process plan is partitioned into a plurality of operating steps, the operation of the integrated browser-based inspection system aggregates the list of part characteristics, specification standards or requirements for detailed manufacturing process steps, materials, and portions of a graphical design blueprint or image based on each of those operating steps. The operating steps of the overall manufacturing process plan are be performed by operators within the manufacturing facility or facilities. This aggregated list of part characteristics and specification standards or requirements for detailed manufacturing processes may be collectively referred to as a list of inspection characteristics. An example list of inspection characteristics is shown at 103. In an aspect, a plurality of physical dimensions, tolerances, or geometric rules are listed for the manufactured part at the relevant operating step of the manufacturing process plan. At 107, inspection characteristic number 5 is shown in an example embodiment. Inspection characteristic 5 displays geometric, dimension and tolerance (GD&T) data establishing an inspection level for a portion of manufacture of the part. Further at 110 and 111, upper side limits and lower side limits set a boundary for inspection of the part dimension during or after performance of the operating step.

The browser-based inspection system of the present disclosure may use ballooning software to overlay callout identification balloons onto a 2D or 3D CAD drawing or other images of the part to be manufactured. Both the ballooning software and the inspection characteristic identification and extraction software may be considered to be distinct sets of code instructions in that these functions may be performed prior to operation of the integrated, browser-based inspection system to generate a graphically guided manufacturing and inspection process for each operational step of an overall manufacturing process plan. In other embodiments, one or both of the ballooning software and the inspection characteristic identification and extraction software may be considered to be fully part of the integrated browser-based inspection system of the present disclosure.

Balloon 113 is designated as number 5 and highlights a portion of the 2D CAD drawing 105 of the part to be manufactured. Balloon designation number 5 at 113 corresponds to inspection characteristic number 5 at 107 in the list of characteristics 103. Data including GD&T levels 109, and upper side limit 110 and lower side limit 111 among other relevant data is readily available for inspection characteristic number 5 at 107 and displayed for quick cross reference to the physical location on the browser-based inspection screen graphical user interface 100. Additionally, conducting inspection on the inspection characteristic number 5 is made more simply with the characteristic parameters extracted from the several technical data package materials and graphically linked with the CAD drawing location for the inspected part. Other balloon callouts are shown for the CAD drawing 105 in FIG. 1. Balloon 114 is shown highlighting inspection characteristic number 6 which corresponds that listed in 103. Similarly, balloons 115, 116, 117, and 118 callout inspection characteristic numbers 7, 8, 9, and 10 respectively and which are shown in list 103 above.

The graphical user interface of the integrated browser-based inspection system as shown in FIG. 1 is customized to specific operating steps such that focus on the ballooned CAD drawing 105 will display the relevant portions of the manufactured item for the operating step. In the example embodiment of FIG. 1, a “lower plate” is shown as a 2D CAD drawing. In the example embodiment, inspection characteristics 1-10, some corresponding to balloons 113-118, are the inspection characteristics relevant to the operating step for an operator fabricating the lower plate described in FIG. 1. Additional discussion and aspects of the browser-based inspection system and its operation in conducting inspection are described below.

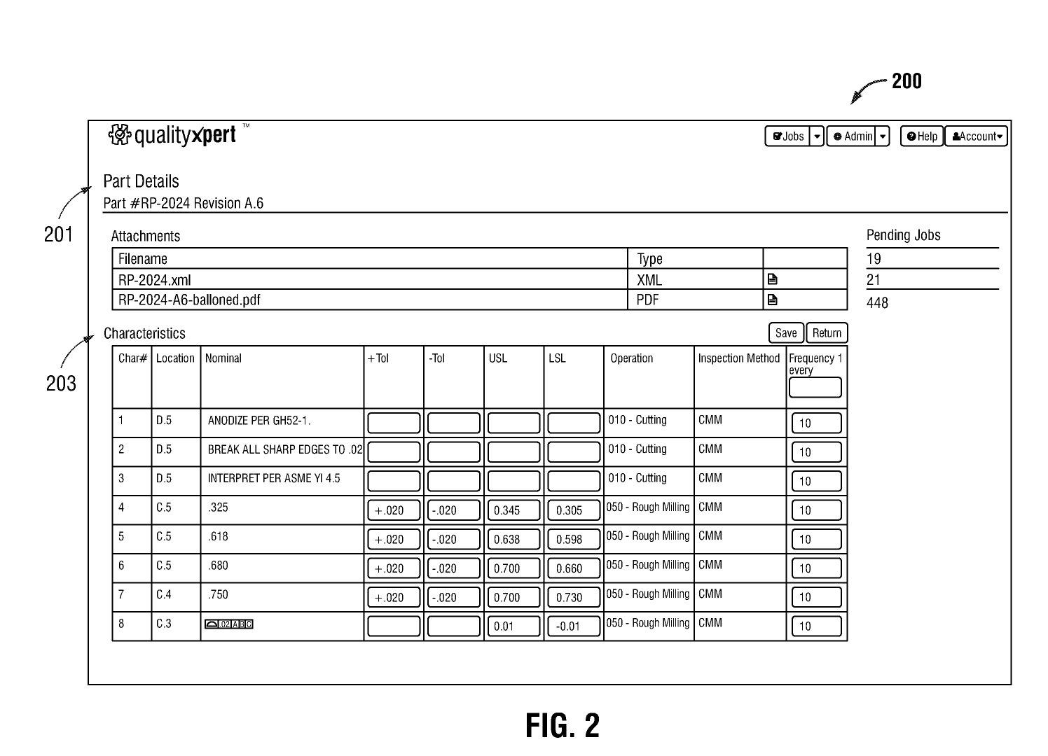

FIG. 2 shows a graphical user interface 200 illustrating an example embodiment of a browser-based inspection system for manufacturing items and conducting field inspections according to another aspect of the present invention. At 201, the browser-based inspection system displays information describing a part number and a revision number. Attachments relevant to the part and revision number may also be made accessible in some aspects. Additional identifying details may be provided on a graphical user interface including job designation data as described above.

As described above, the technical data package for the ordered manufacture of the manufactured item or part may also contain process specification standards for manufacturing process steps such as provided with a bill of specification in an aspect of the present disclosure. From the manufacturing process management creation of an overall manufacturing process plan with a series of operational steps to manufacture a part, specific detail on standards of how detailed manufacturing steps are conducted and what parameters are required is aggregated by the integrated, browser-based inspection system. At 203, a list of inspection characteristics relevant to an operating step for detailed process specifications are displayed on a graphical user interface 200 of the browser-based inspection system. In one specific embodiment, the list 203 may be a sequenced list of detailed manufacturing process steps to be conducted at a manufacturing plan operating step. As shown at 203, a plurality of detailed manufacturing process steps are specified and the engineering requirements or standards to which the work is to be performed are shown. Operations include a cutting operation and a rough milling operation. Inspection characteristics for the detailed manufacturing process step specifications for cutting include inspection characteristic number 1 requiring anodizing per a specified standard as shown in the embodiment of FIG. 2. Inspection characteristic number 2 requires breaking all sharp edges to a specified level, and inspection characteristic number 3 requires a standard be met relating to the American Society of Mechanical Engineer (ASME) dimension and tolerance standards in the embodiments shown in FIG. 2.

Inspection characteristic numbers 4-8 of FIG. 2 further relate to a rough milling operation including dimensions and tolerances as well as specification limits for those part characteristics that serve as inspection characteristic numbers 4-8 and as displayed by the integrated, browser-based inspection system of the present disclosure.

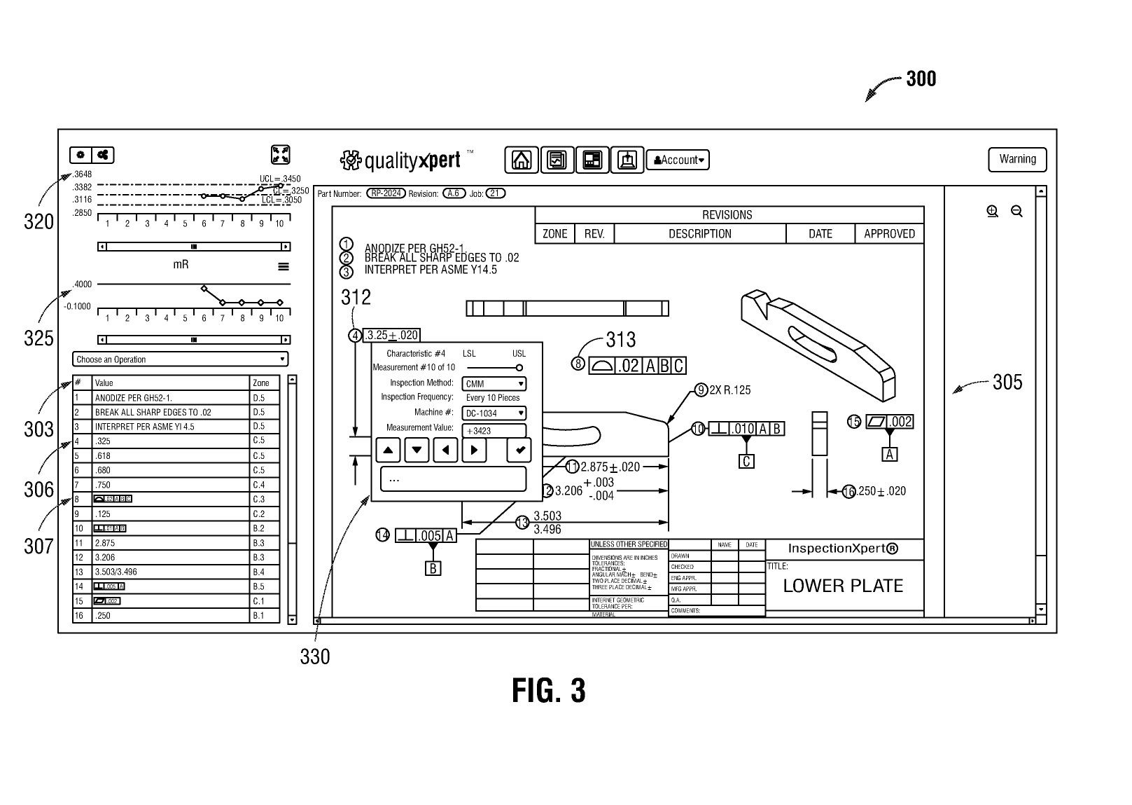

FIG. 3 shows a graphical user interface 300 illustrating another example embodiment of a browser-based inspection system for manufacturing items and conducting field inspections according to another aspect of the present invention. Graphical user interface 300 of FIG. 3 shows additional features of the browser-based inspection system of the present disclosure. In one embodiment of the present disclosure, a sequence list of inspection characteristics 303 (sequence numbers matching balloon callouts 312, 313 on a 2D drawing 305), a measurement entry form 330 for entering actual measurement results for a chosen inspection characteristic 306, a status notification icon/graphic for communicating status of a chosen inspection characteristic and graphical charts 320 and 325 for graphically illustrating inspection results including but not limited to statistical process control charts are some example additional features of the browser-based inspection system disclosed herein.

At 305, the graphical user interface 300 displays both 2D and 3D CAD images in an example embodiment. Further at 305, two views of a 2D CAD image of the part to be manufactured are displayed with balloons such as 312 and 313. At 303 a sequenced list of inspection characteristics is displayed relevant to various detailed manufacturing process specifications and dimension part characteristics similar to that described in FIGS. 1 and 2 above. In the example embodiment, the inspection characteristics numbered in 303 are sequenced and the embodiment shows inspection characteristic number 4 relating to a rough milling operation corresponding to balloon number 4 at 312. Similarly, inspection characteristic number 8 at 307 corresponds to balloon number 8 at 313 in the displayed part drawing 305. It is understood, additional balloons for the part drawings of 305 may also correspond with sequenced inspection characteristics in list 303 in some embodiments. In an aspect of the present disclosure, the list of characteristics 303 may be depicted with additional information about the listed inspection characteristic as part of the sequenced list 303. In graphical interface 300, the additional information about the inspection characteristics shown in list 303 include a coordinate location in a grid of the relevant 2D or 3D part drawing 305. This coordinate location may assist in navigation of a complex drawing of a manufactured part or system in one aspect.

At 330, an inspection measurement entry form is shown to permit acquisition of actual inspection measurement results. Inspection measurement entry form 330 may appear during or after an operating step and may require collection of inspection measurement data before proceeding. The inspection measurement form 330 may pop up at a location on the graphical user interface overlaid on a manufactured product CAD image 305 at the balloon location currently being inspected and operated on. In the example embodiment, the inspection measurement entry form 330 appears at balloon number 4 at 312 indicating inspection measurements being conducted for inspection characteristic number 4 at 306. In an example aspect of the present disclosure, inspection characteristic number 4 at 306 may be selected such that it is highlighted as shown. In a further example aspect, this selection may trigger display of the inspection measurement entry form 330 near balloon callout number 4 at 312 on the 2D drawing 305. Measurement details of the recorded inspection measurement may appear on the measurement entry form 330 as described further below. It is contemplated that inspection measurements may be entered into measurement entry form 330 by an operator responsible for performing an operating step in the manufacturing process plan in some embodiments. In other embodiments, probes or gauges relating to the manufacturing machine or an inspection machine may feedback inspection measurements for the operating step being conducted by the operator. Those linked feedback measurements may appear in the measurement entry form 330 for review by the operator in some embodiments.

In an additional aspect, a graphical depiction of ongoing inspection measurements may be displayed in the graphical user interface 300. As inspection measurements are conducted, a graphical depiction such as 320 showing inspection measurements over instances of inspection during a job or a graphical depiction such as 325 showing a moving range of inspection measurements over the course of inspection measurements may be displayed. It is understood that any form of graphical representation of inspection measurements conducted during the course of a manufacturing job may be used to assist the operator or management of the manufacturing process plan. The present disclosure is not necessarily limited to the presently depicted forms at 320 and 325.

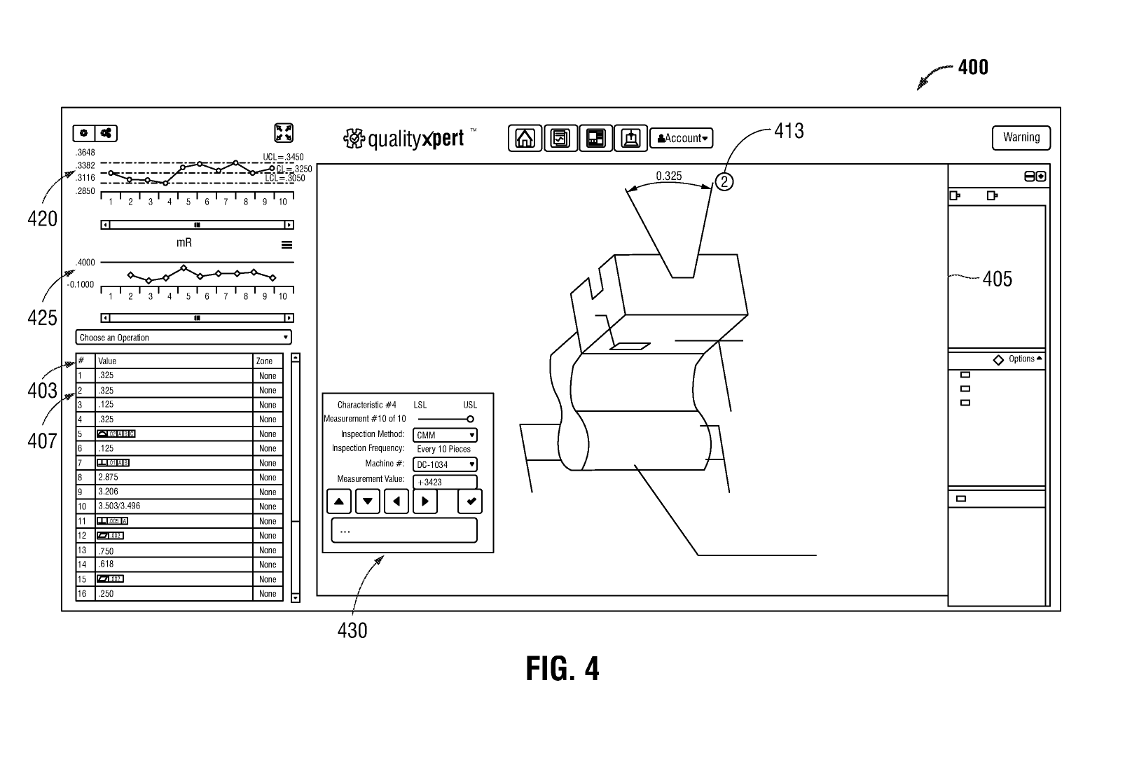

FIG. 4 shows a graphical user interface 400 illustrating another example embodiment of a browser-based inspection system for manufacturing items and conducting field inspections according to another aspect of the present invention. Graphical user interface 400 of FIG. 4 shows additional features of the browser-based inspection system of the present disclosure. Graphical user interface 400 of FIG. 4 is an analogous illustration to graphical user interface 300 of FIG. 3 but shows a 3D CAD drawing 405 of a part to be manufactured. 3D CAD drawing 405 of the part to be manufactured includes ballooned callouts similar to those shown in FIG. 3 highlighting particular part characteristics or manufacturing process specification standards required to fabricate highlighted portions of the manufactured part. The balloon callouts correspond to inspection characteristics shown at 403.

Graphical user interface 400 of FIG. 4 analogously depicts a sequence list of inspection characteristics 403 (sequence numbers matching balloon callouts on 3D model 405), a measurement entry form 430 for entering actual measurement results for a chosen inspection characteristic 407, a status notification icon/graphic for communicating status of a chosen inspection characteristic, and graphical charts 420 and 425 for graphically illustrating inspection results including but not limited to statistical process control charts, according to an embodiment of the present disclosure. Operation of the integrated, browser-based inspection system is similar to embodiments described elsewhere herein including that of FIG. 3. The graphical user interface 400 of FIG. 4 could provide for three dimensional panning of the 3D part image 405 in accordance with understood 3D image depiction such as 3D CAD imaging in some embodiments. Balloon callouts overlaid on the 3D part image 405 may also pan in a three dimensions as the 3D image pans to maintain the balloon callouts highlighting the same portions of the manufactured part from different angles.

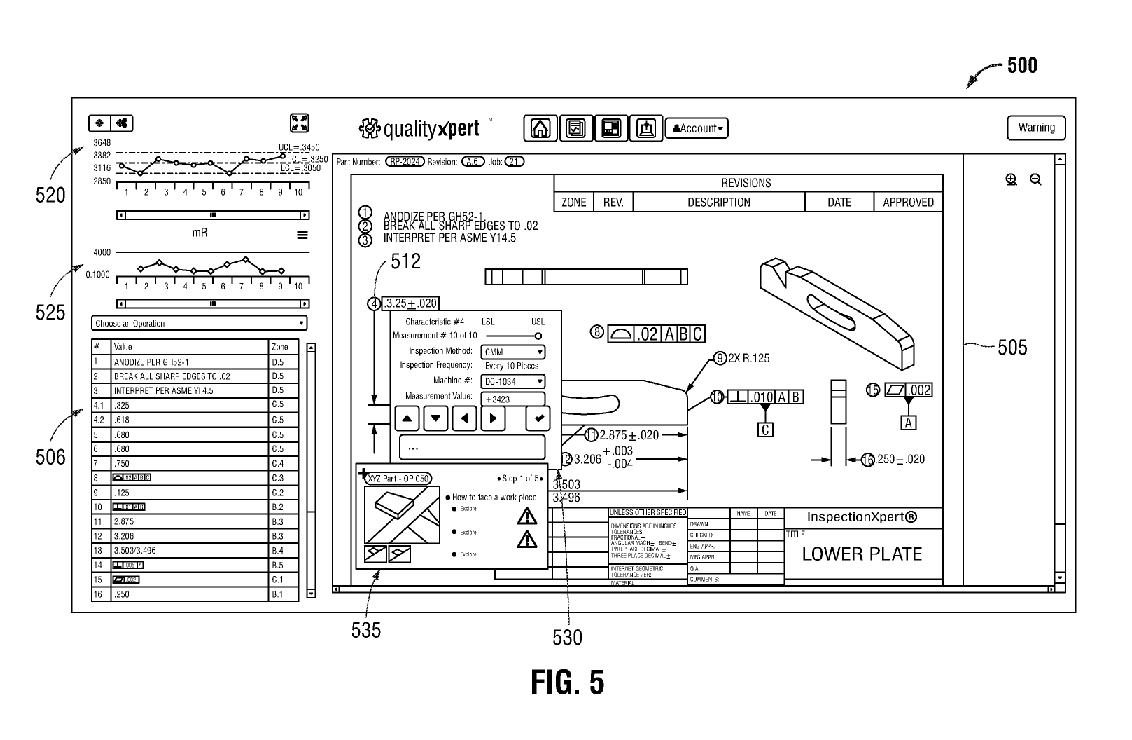

FIG. 5 shows a graphical user interface 500 illustrating another example embodiment of a browser-based inspection system for manufacturing items and conducting field inspections according to another aspect of the present invention. Graphical user interface 500 of FIG. 5 shows additional features of the browser-based inspection system of the present disclosure. Graphical user interface 500 of FIG. 5 is similar in parts to the graphical user interface 300 of FIG. 3 but shows a displayed set of selectable work instructions available to an operator for an operating step of an overall manufacturing plan for a part. In an embodiment of the present disclosure, a sequence list of inspection characteristics (sequence numbers matching balloon callouts such as 512 on 2D drawing 505), a measurement entry form 530 for entering actual measurement results for a chosen inspection characteristic 506 from the list of characteristics, a status notification icon/graphic for communicating status of a chosen inspection characteristic, and graphical charts 520 and 525 for graphically illustrating inspection results including but not limited to statistical process control charts. In addition, the example graphical user interface 500 of the integrated, browser-based inspection system depicts visual work instructions 535 for the item being inspected, according to an embodiment of the present invention. The visual work instructions 535 may be specific to the operating step of the identified operator performing the manufacturing work. The visual work instructions 535 may also be selectable to obtain particular steps or descriptions of the operating step within the manufacturing process plan. The visual work instructions 535 provide graphical and textual instructions for an operating step and may be similar to manufactured part characteristics and manufacturing process specification standards however the latter two aspects relate to the dimension, material, manufacturing process activity standards as the desired result of those aspects of the operating step rather than instructions of how to perform an operating step with regard to the manufacturing process plan for the manufactured part. Visual work instructions 535 may require a sequence of steps in some embodiments. In other embodiments, the manufacturing steps may be performed in parallel or any order. A sequence list of inspection requirements also does not necessarily require inspections be performed in any particular sequence either and may be inspected in sequence, in parallel, or in any reasonable order in various embodiments.

A selected inspection characteristic, such as number 4 at 506 may be chosen and the selection highlighted in some embodiments. The selected characteristic corresponds to a rough milling operation corresponding to balloon number 4 at 512. Selection of the inspection characteristic 506 may also open an inspection measurement entry form 530 for the operating step being performed to fabricate that aspect of the part. In the shown embodiment, selection of 506 may open an inspection measurement entry form 530 specific to this inspection characteristic of the rough milling procedure. This inspection measurement entry form 530 will require collection of inspection data for monitoring whether the manufacturing is within specifications or standards required for the part or the process used to fabricate the part. In addition, a selectable set of instructions 535 may arise relating to the processes relating to inspection characteristic number 4 at 506. The instructions 535 relate to how to fabricate the part at that point in the manufacturing process and which is highlighted by balloon 512. Interaction with the selectable instructions at 535 may provide an operator at the operating step of the manufacturing plan settings for the instrumentation, settings for an inspection gauge and probe usage, part placement in the manufacturing machine, material to be used, an order of procedural steps, or aspects for conducting detailed manufacturing processes at the operating step such as time, temperature, cutting speed, depth, thickness, and the like.

It is contemplated that inspection measurements may be entered into measurement entry form 530 by an operator responsible for performing an operating step in the manufacturing process plan in some embodiments. In other embodiments, probes or gauges relating to the manufacturing machine may feedback inspection measurements for the operating step being conducted. The feedback measurements may appear in the measurement entry form 530 and be viewable by the operator as described above.

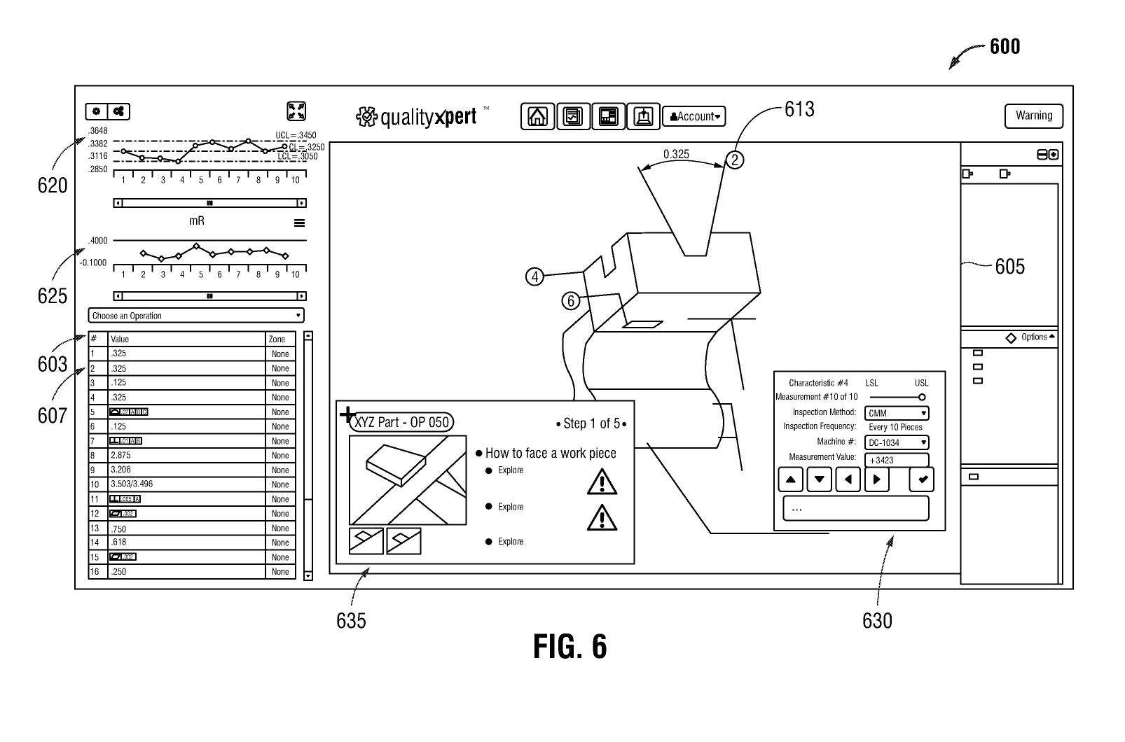

FIG. 6 shows a graphical user interface 600 illustrating another example embodiment of a browser-based inspection system for manufacturing items and conducting field inspections according to another aspect of the present invention. Graphical user interface 600 of FIG. 6 shows additional features of the browser-based inspection system of the present disclosure. Graphical user interface 600 of FIG. 6 is similar to graphical user interface 500 of FIG. 5 in certain respects, but shows a 3D CAD drawing 605 of a part to be manufactured. FIG. 6 includes, in some embodiments, a sequence list of inspection characteristics (sequence numbers such as 607 matching balloon callouts such as 613 on 3D model 605), a measurement entry form 630 for entering actual measurement results for a chosen inspection characteristic 607, a status notification icon/graphic for communicating status of a chosen inspection characteristic, and graphical charts 620 and 625 for graphically illustrating inspection results including but not limited to statistical process control charts. The graphical user interface 600 further includes visual work instructions 635 for the item being inspected, according to embodiments of the present invention.

The 3D CAD drawing 605 of the part to be manufactured includes ballooned callouts similar to those shown in FIG. 4 above. The balloon callouts highlight particular part characteristics or detailed manufacturing process specifications required to fabricate highlighted portions of the manufactured part indicated by the balloon callout. The part characteristics or detailed manufacturing process specifications comprise inspection characteristics. Further, the balloon callouts correspond to inspection characteristics such as those numbered in the list of inspection characteristics of graphical user interface 600. An example inspection characteristic that may be chosen. A chosen inspection characteristic, such as number 2 at 607, may be highlighted in some embodiments. Inspection characteristic number 2 at 607 may correspond to a balloon callout 613 on the 3D CAD image 605. Selection of an inspection characteristic number such as 607 may also raise an inspection measurement form 630 for receiving inspection measurements in an embodiment as described in various parts of the present disclosure. The inspection measurement form 630 may relate to inspection requirements of inspection characteristic number 2 selected at 607. An additional feature shown in graphical user interface 600 of the integrated, browser-based inspection system is the availability of work instructions 635. Work instructions 635 may be displayed and contain instructions relating to the operating step being conducted from the overall manufacturing process plan. The instructions 635 provide a description of how to perform the detailed manufacturing processes of the operating step developed for the manufacture of a part. Instructions 635 may be selectable and interactive to provide access to additional manufacturing process description or other details as needed by an operator in some embodiments. This feature is conveniently accessible at the browser-based inspection screen of the present embodiments and may also be easily associated by the operator with the operating step being conducted and with the visual image of the part to be manufactured at relevant coordinates of that image.

As with the embodiment shown in FIG. 4, the graphical user interface 600 of FIG. 6 could provide for three dimensional panning of the 3D part image 605 in accordance with understood 3D image depiction including 3D CAD imaging in some embodiments. Balloon callouts overlaid on the 3D part image 605 may also pan in a three dimensions as the 3D image pans to maintain the balloon callouts highlighting the same portions of the manufactured part from different angles.

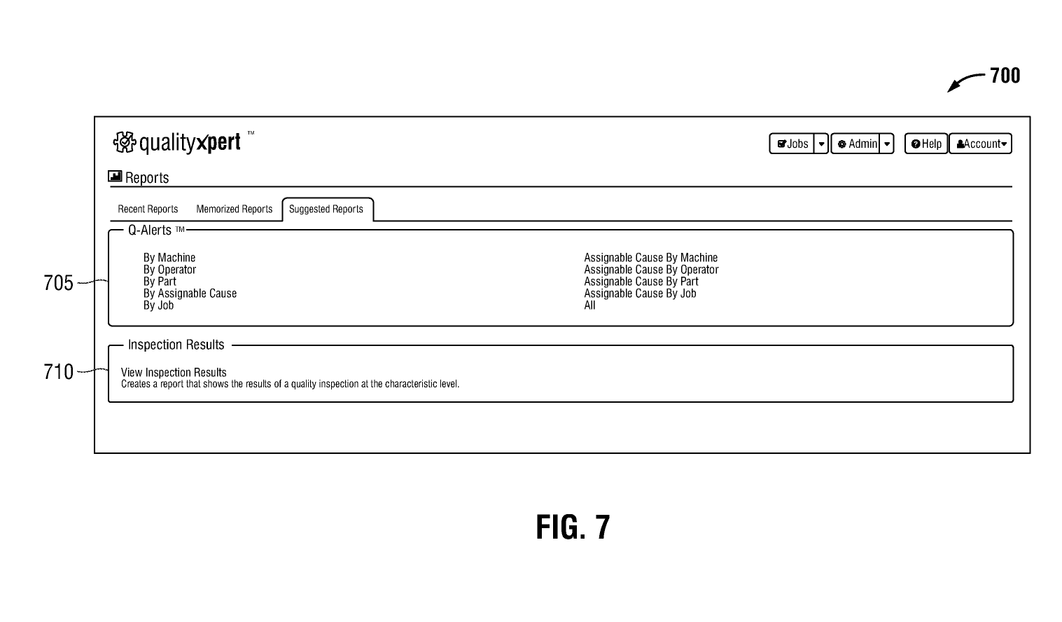

FIG. 7 shows another example embodiment of a management aspect of the browser-based inspection system for manufacturing items and conducting field inspections according to the present disclosure. Graphical user interface 700 of FIG. 7 shows an aggregated list of available quality reports including overall inspection results 710 and various non-conformance reports 705 conducted using the integrated, browser-based inspection system according to an embodiment of the present invention. The graphical user interface includes a searchable list of non-conformance alerts 705 reporting quality inspection failures detected with the browser-based inspection system of the present disclosure. In an embodiment, the non-conformance reports relate to inspections that fall outside the standard limits for a dimension, process measurement, or other inspection characteristics or aspects of the manufacture of a part. The non-conformance reports 705 may be searched by machine, by operator, by part, by an assignable cause relating to information supplied about inspection failures, or by a job in example embodiments. The non-conformance reports 705 are also referred in the Figures as Q-Alerts™. The graphical user interface 700 of FIG. 7 may be used for management of a manufacturing facility or to determine job or part production quality. Graphical user interface 700 may also be useful for expedient access to review quality inspection failures for diagnosis of system and processes of manufacture or the manufacturing facility or facilities. Such non-conformance reports 705 and overall inspection results 710 may be aggregated at a centralized database for review by quality engineers or manufacturing management.

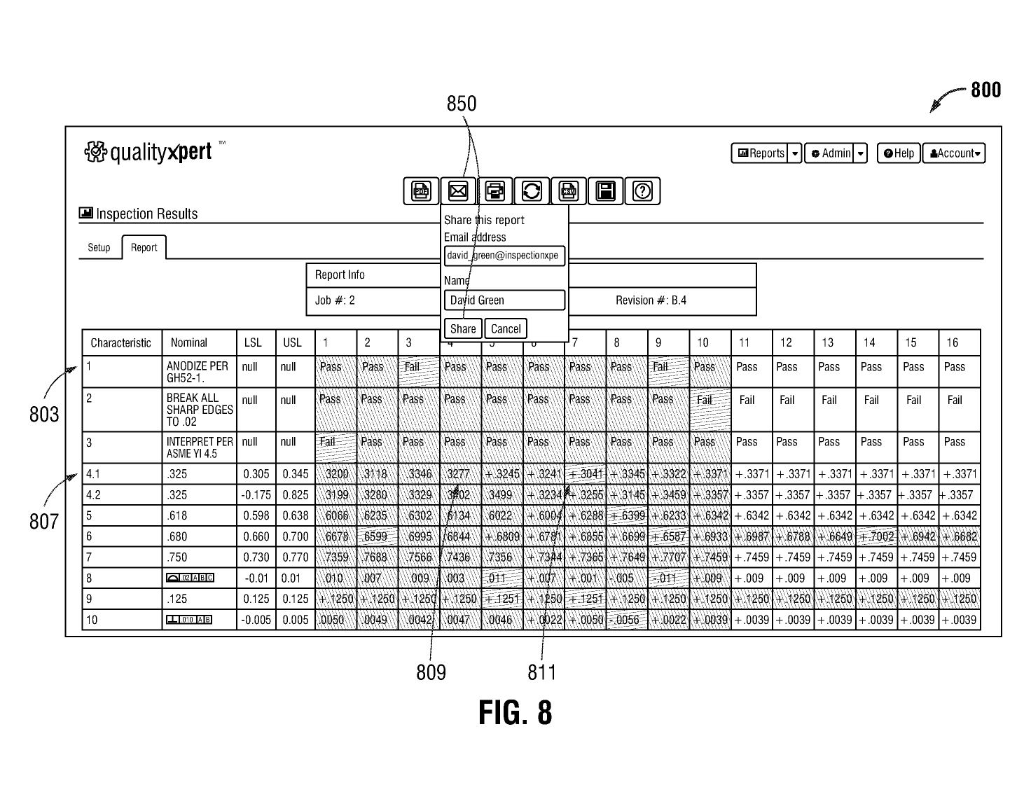

FIG. 8 shows another example embodiment of a management aspect of the browser-based inspection system for manufacturing items and conducting field inspections according to the present disclosure. Graphical user interface 800 of FIG. 8 shows an aggregated list of overall inspection results that may be an example of what may be available by selection of 710 of FIG. 7. The aggregated overall summary inspection report may be used by a quality engineer or other manufacturing process manager to analyze the results of whether inspection measurements of various characteristics and manufacturing process specification standards has been met. Shown is a sequenced list 803 of inspection characteristics that may include manufactured part characteristics or detailed manufacturing process specifications. For an example inspection characteristic such as number 4-1 at 807, a nominal inspection measurement level and a lower side limit and upper side limit are shown as available data in the summary inspection report. Further shown are several inspection measurements displayed in a grid. For inspection characteristic number 4-1 at 807, ten valid inspection measurements are shown in the present embodiment (although 16 fields appear in the shown embodiment, the latter six fields of 807 are repeated values). Inspection measurements are shown in the ten fields and include inspection measurements 809 and 811. An indicator may show which inspection measurements fall within specification or standards limits and which may not. In the embodiment of FIG. 8, highlighting is used for inspection measurement field 809 to indicate an acceptable inspection measurement. A different indicator may be used for inspection measurements that fall outside of specification limits or do not meet engineering requirements of an inspection characteristic. In the embodiment shown in FIG. 8, a different highlighting of inspection measurement field 811 is used to indicate an out of specification measurement entry.

In another aspect of the present disclosure, detailed manufacturing process step specification requirements and standards such as shown for inspection characteristic numbers 1, 2, and 3 in list 803 may display a determination of whether the inspection assessments have passed or failed the specification standard or engineering requirement without necessarily showing specific measurement results. In such example embodiments, inspection characteristic numbers 1, 2, and 3 do not include specified side limits, designated instead as null. Instead, a particular manufacturing standard may be required to be met. This may include standards or engineering specification requirements such as a detailed manufacturing process achieve a particular threshold heat level, induction level, hardness level, or the like.

In the shown embodiment of FIG. 8, the aggregated inspection measurements of graphical user interface 800 are a summary of inspection results for a job (#2) relating to a part manufacture and revision number (8.4). In a further aspect of the present disclosure, graphical user interface 800 of the browser-based inspection system provides for a capacity to share summary results of an inspection as shown at 850. The summary inspection results may be shared with an operator, a co-worker, a customer, a partner, a supplier or an auditor. Some or all of the summary quality inspection results may be shared with the integrated, browser-based inspection system.

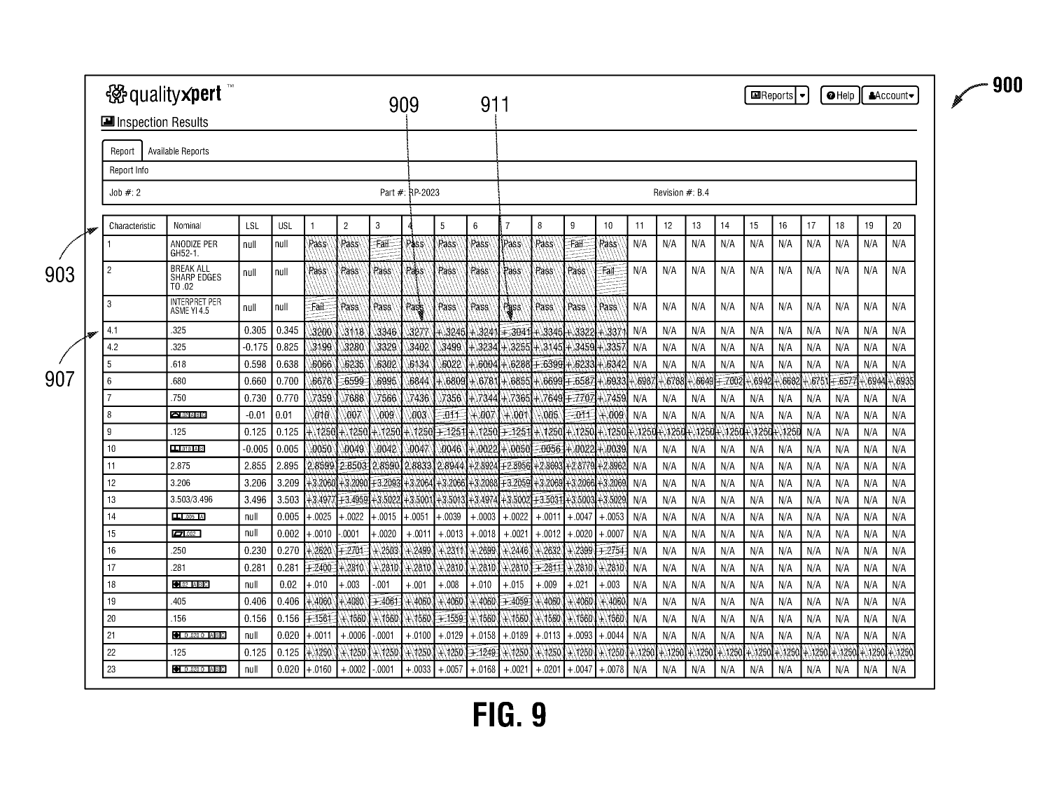

FIG. 9 shows another example embodiment of a management aspect of the browser-based inspection system for manufacturing items and conducting field inspections according to the present disclosure. Graphical user interface 900 of FIG. 9 shows an aggregated list of overall inspection results that may be an example of what may be shared by selection of a sharing option 850 of FIG. 8. FIG. 9 is shows a graphical user interface of a summary inspection report as being seen by a customer, co-worker, partner, supplier or auditor according to an embodiment of the present invention.

As shown, an example embodiment of a shared view of the aggregated inspection measurements in graphical user interface 900 and are a summary of inspection results for a job (#2) relating to a part for manufacture (#RP-2022) and revision number (8.4). In a further aspect of the present disclosure, graphical user interface 900 of the browser-based inspection system provides the shared view summary results of an inspection including a sequenced list 903 of inspection characteristics including manufactured part characteristics or manufacturing process steps and specifications. In the shown embodiment and similar to FIG. 8, part inspection characteristic such as number 4-1 at 907 has a nominal inspection measurement level, a lower side limit, an upper side limit, and several inspection measurements in a grid. For inspection characteristic number 4-1 at 907 ten valid inspection measurements are shown including inspection measurements 909 and 911. An indicator, such as highlighting shows which inspection measurements fall within specification or standards limits such as the highlighting used for inspection measurement field 909 and different highlighting may be used for inspection measurements that fall outside of specification limits or do not meet standards requirements such as used for inspection measurement field 911. As described above, any visual indicator may be used.

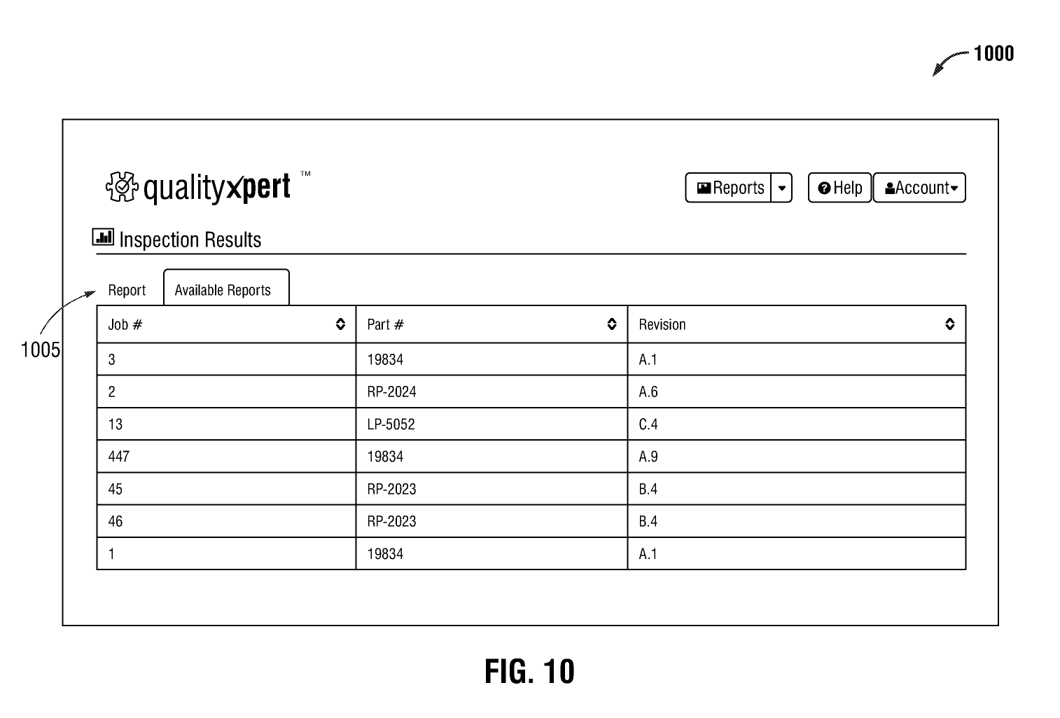

FIG. 10 shows yet another example embodiment of a management aspect of the browser-based inspection system for manufacturing items and conducting field inspections according to the present disclosure. Graphical user interface 1000 of FIG. 10 shows a selectable list of inspection reports 1005 shared such as via the embodiment of FIG. 8. The listing of reports shared via the browser-based inspection system may be sorted and displayed according to with whom the inspection reports where shared. For example, some summary inspection reports may be shared with a specific customer or supplier, others may be shared with the machine technician. The selectable list of inspection reports 1005 provides a view of what has been distributed and what aspects of the inspections have been shared with others. The shared inspections in the shown embodiment of 1000 may be selectable and broken down by job number, part number, and revision. In this way a manufacturing process or facility manager or a quality engineer may manage and view what has been shared and the detail of the reports shared from the integrated, browser-based inspection system. It is contemplated that sharing inspection data for a manufacturing process plan may be sensitive information and only partial aspects of the summary of inspection results may only be relevant to certain parties with which the information is shared. For example a supplier of a machine may only need to see the inspection report relating to failures reported at the machine supplied.

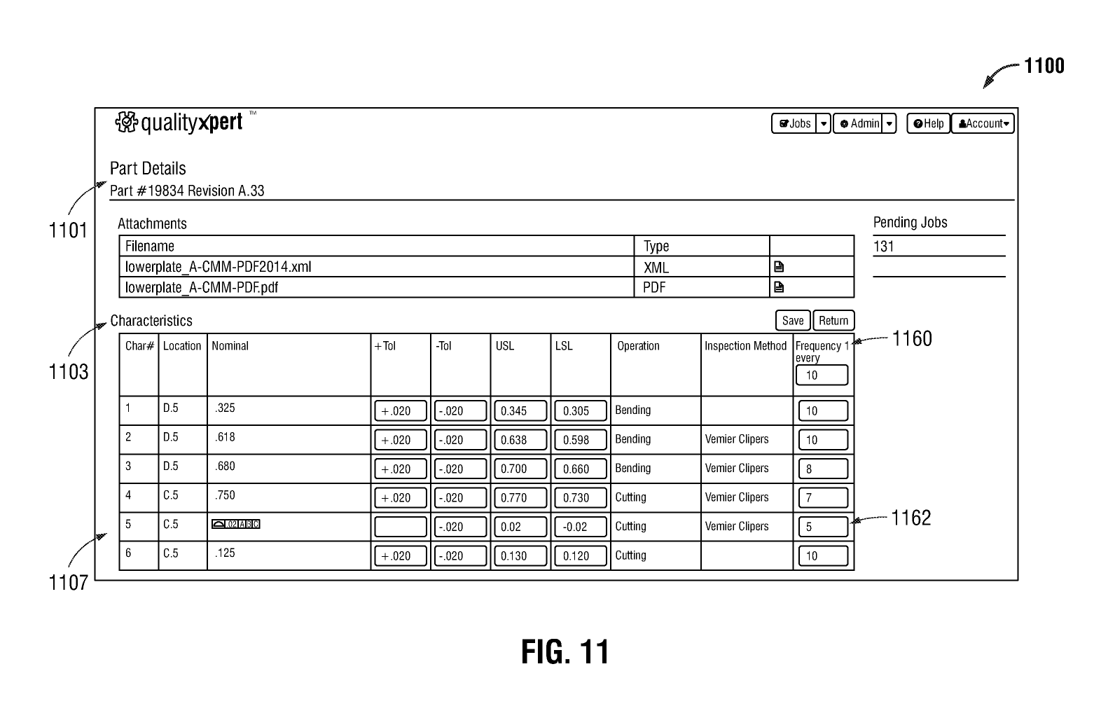

FIG. 11 shows another example embodiment of an aspect of the browser-based inspection system for manufacturing items and conducting field inspections according to the present disclosure. Graphical user interface 1100 of FIG. 11 shows an example embodiment of a browser-based inspection system for manufacturing items and conducting field inspections according to another aspect of the present invention. Graphical user interface 1100 is similar to that of FIG. 2 and includes a display of information describing a part number and a revision number at 1101 (Part #19834 and Revision A.33). Attachments relevant to the part and revision number may also be made accessible in some aspects as shown. At 1103, a list of inspection characteristics relevant to the operating step for process specifications is displayed on a graphical user interface 1100 of the browser-based inspection system. In one specific embodiment, the list 1103 may be a sequenced list of manufacturing process steps to be conducted at a manufacturing plan operating step and include a part characteristic 1107 that is numbered inspection characteristic number 5. In other embodiments, the sequenced list of inspection characteristics at 1103, need not indicate any order of performing manufacturing steps or inspections. Inspection characteristic number 5 at 1107 includes a dimension, geometric requirements, tolerance, upper and lower side levels, and a description of the operating step or manufacturing process step. In the shown embodiment, the operation is a cutting. As shown at 1103, several manufacturing process steps are specified and the standards to which the work is to be performed are shown in inspection characteristics 1 through 6. Operations include a bending operation and a cutting operation for example. Inspection specifications for the manufacturing process steps or part characteristics may include description of the inspection method. In the example embodiment of 1107, inspection is made via Vermier caliper measurement of the inspected part. At 1160, graphical user interface 1100 provides for settings for the inspection frequency via the integrated, browser-based inspection system. The inspection frequency may be set for all inspection characteristics in list 1103 and the setting may be entered at 1160 on the browser-based inspection screen. In another embodiment, each inspection characteristic may have a custom inspection frequency setting as shown at 1162 for inspection characteristic number 5. In one example embodiment at 1160, the overall inspection frequency may be set an inspection of one part for every ten parts manufactured. In another example embodiment at 1162, one part is inspected for every five parts manufactured.

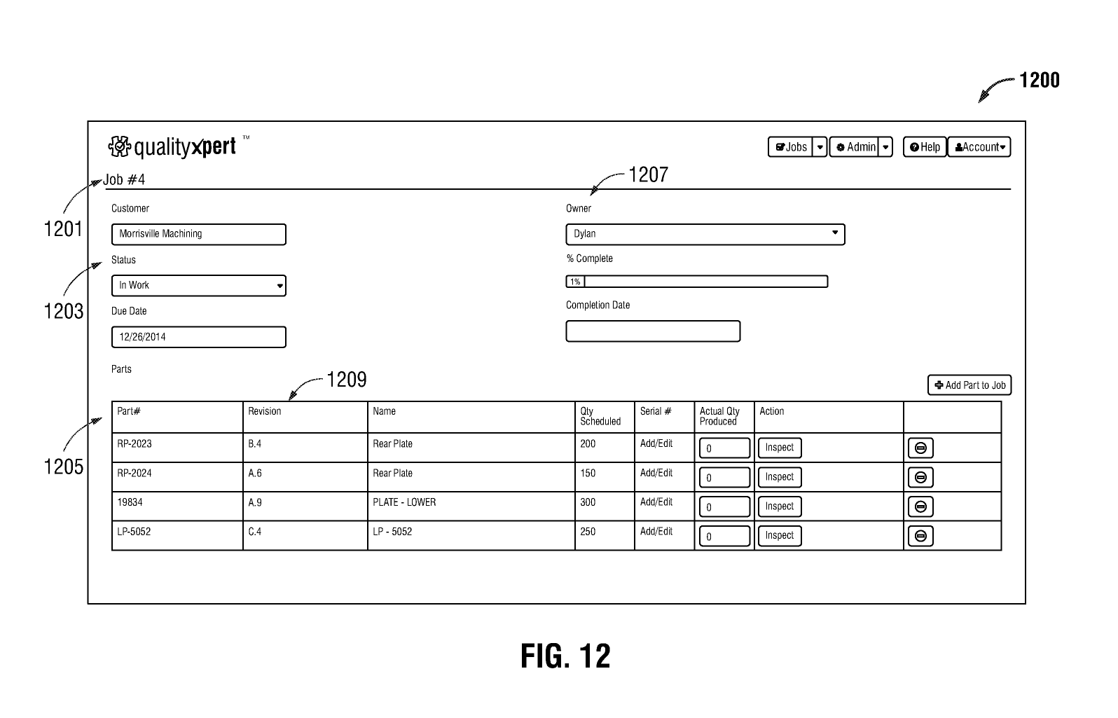

FIG. 12 shows an example embodiment of an aspect of the browser-based inspection system for manufacturing items and conducting field inspections according to the present disclosure relating to information communicated to an operator within a manufacturing facility. Graphical user interface 1200 shows a traveler sheet or job setup screen delivered to an operator indicating jobs assigned to an operator from a variety of manufacturing process plans created for the manufacturing facilities. Job setup screen 1200 may also include the inspection requirements to be conducted via the integrated, browser-based inspection system of the present disclosure. The job setup screen graphical user interface 1200 includes information for the operator including job details such as job number 1201, job owner 1207, job due date, job status 1203 and parts to be made and/or inspected 1205 for the job in connection with operation of the browser-based inspection system of the present disclosure. The parts to be made and inspected will include information including part number, revision, name or description, quantity scheduled and an actual quantity completed indicator for the operator to view. Additional information relating to the operator and operating step for one or more manufacturing process plans may also be included in the job setup screen graphical user interface 1200.

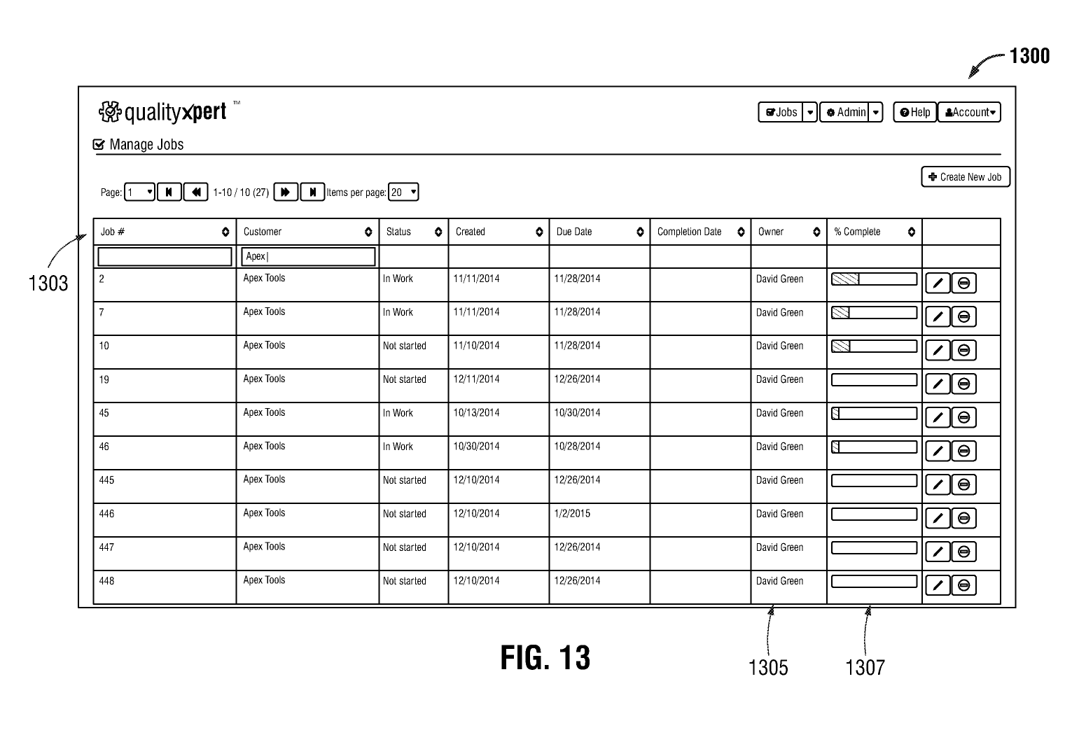

FIG. 13 shows an example embodiment of a management aspect of the browser-based inspection system for manufacturing items and conducting field inspections according to the present disclosure relating to information communicated to an operator within a manufacturing facility. Graphical user interface 1300 is a list of manufacturing and inspection jobs with user interface elements for the user to filter the jobs to be shown according to an embodiment of the present disclosure. For example, a listing or selection of the job by number may be made at 1303. In another example embodiment, selection of inspection and/or manufacturing jobs by operator may be made at 1305. An indication and selection option based on percentage of completion of a job may be made to find a list of jobs at 1307 in yet another embodiment. Other example embodiments of selection of manufacturing and inspection jobs from among a centralized database of jobs may include selection by name of a customer, status of the job, date job was created, date job is due, or other factors.

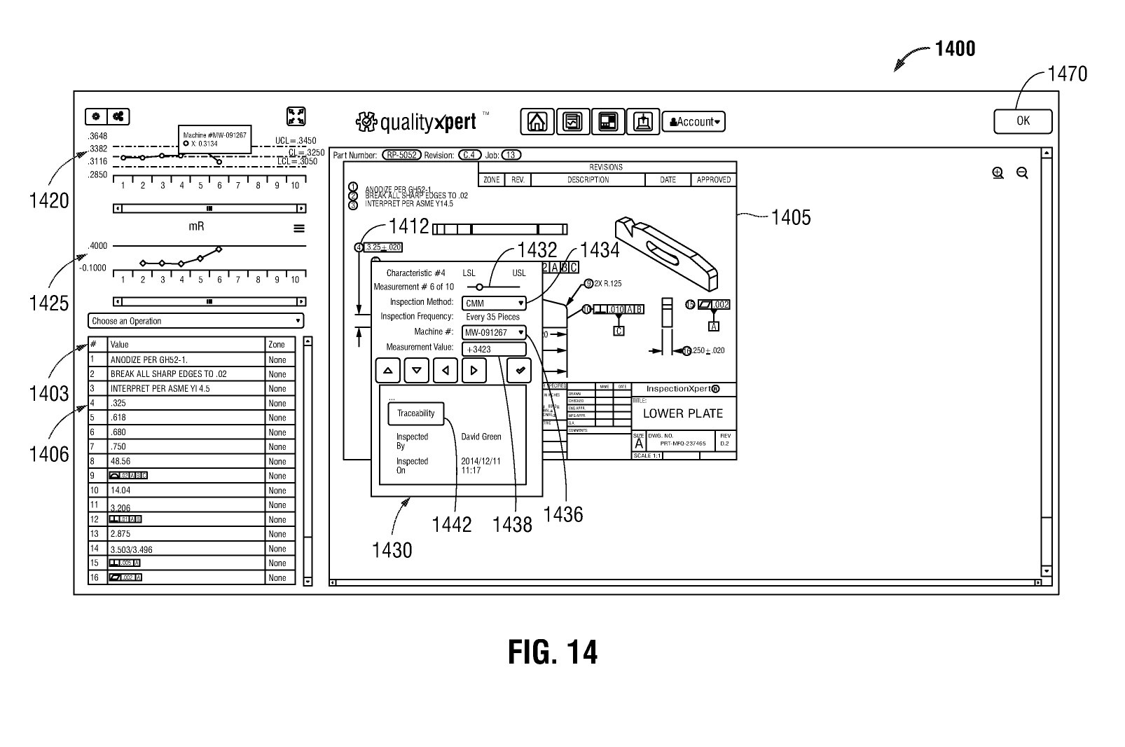

FIG. 14 shows an example embodiment of the browser-based inspection system for manufacturing items and conducting field inspections according to the present disclosure relating to inspection measurements taken during an operating step of a manufacturing plan. FIG. 14 includes a sequence list of inspection characteristics such as 1406 with matching balloon callouts such as 1412 on 2D model 1405, a measurement entry form 1430 for entering actual measurement results for a chosen inspection characteristic 1406, a status notification icon/graphic for communicating status of a chosen inspection characteristic 1470, and graphical charts 1420 and 1425 for graphically illustrating inspection results including but not limited to statistical process control charts. In particular, FIG. 14 shows a measurement entry form 1430 showing detail of inspection traceability information gathered. At 1442, traceability information gathered at the measurement entry form 1430 may including who recorded the measurement, when the measurement was recorded. The measurement entry form may also include graphical display of an inspection measurement 1432 corresponding to an inspection measurement entered in measurement entry field 1438. In the example embodiment, the graphical display of the inspection measurement 1432 may include the graphical inspection measurement display relative to the specification limits showing the inspection measurement value as it falls between a lower side limit and an upper side limit of an engineering specification requirement for a part characteristic. At 1434, a menu is provided for selecting an inspection method including selection of an inspection measurement gauge or machine with which to conduct the inspection. For example, the graphical user interface 1400 shows a coordinate measurement machine (CMM) as a selected inspection method and machine to be used to take the measurement reading according to an embodiment of the present invention. At 1436, an identification of the fabrication machine used in the operating step is included as part of the traceability data included in the inspection measurement form 1430 for reporting of inspection measurement data. The graphical user interface 1400 of the browser-based inspection system of the shown embodiment includes the list of part characteristics for inspection at 1403 and includes a selected inspection characteristic number 4 at 1406 with corresponding balloon callout 1412 on an image 1405 of the part to be manufactured.

In the present embodiment, the status notification icon/graphic for communicating status of a chosen inspection characteristic 1470 may indicate that the inspection measurements entered or acquired from inspection measurements conducted during an operating step fall within the upper and lower side limits of the specified value. In the embodiment of FIG. 14, the status notification indicates that the inspection is okay. The graphical value relative to the lower side limit and upper side limit may be shown in the graphical inspection measurement display relative to the specification limits at 1432 and may further indicate that the inspection is okay.

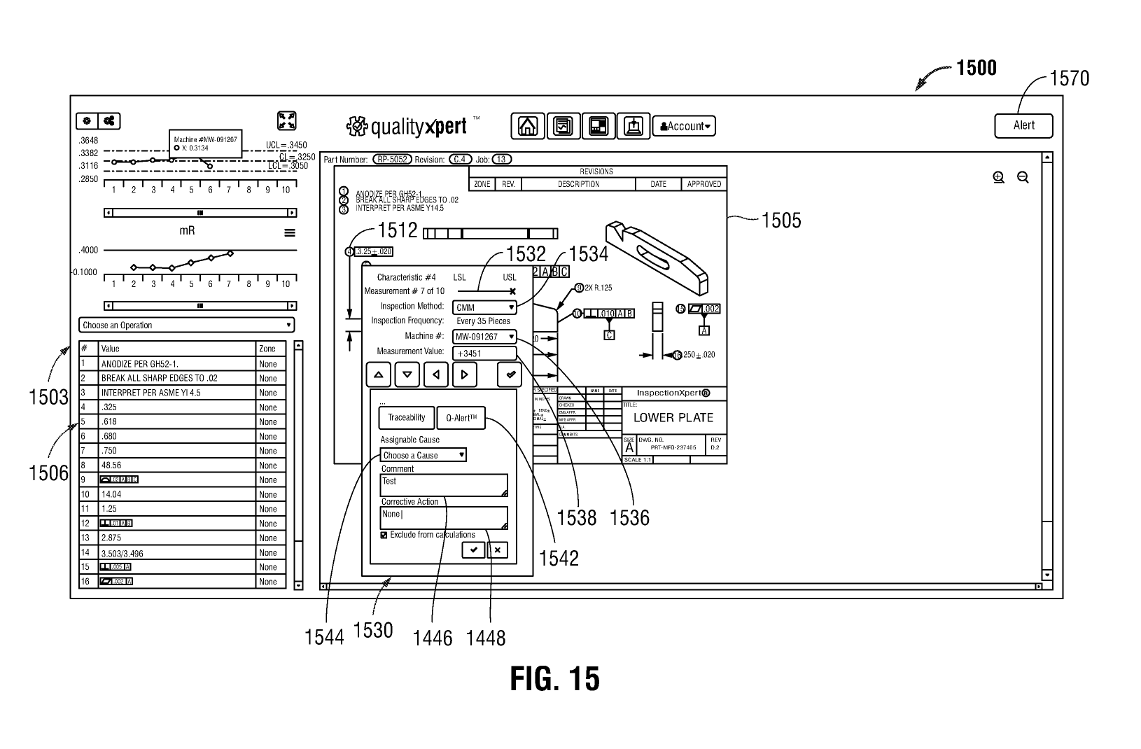

FIG. 15 shows an example embodiment of the browser-based inspection system for manufacturing items and conducting field inspections according to the present disclosure relating to inspection measurements taken during an operating step of a manufacturing plan. FIG. 15 includes, similar to other embodiments described, a sequence list of inspection characteristics such as 1506 with matching balloon callouts such as 1512 on 2D model 1505, a measurement entry form 1530 for entering actual measurement results for a chosen inspection characteristic 1506, a status notification icon/graphic for communicating status of a chosen inspection characteristic 1570, and graphical charts 1520 and 1525 for graphically illustrating inspection results including but not limited to statistical process control charts. FIG. 15 is similar to FIG. 14 above but instead illustrates of an inspection measurement entry form 1530 showing non-conforming measurement 1538 including the cause of the non-conformance 1544, a comment about the cause of the non-conformance 1546 and the action taken to correct the nonconformance 1548 as part of an embodiment of a non-conformance reporting aspect via the measurement entry form 1530 for a characteristic 1506. The non-conforming report menu and entry fields may appear when a non-conforming measurement is received or entered into inspection measurement form 1530 at field 1538 in some embodiments.

Measurement entry form 1530 shows inspection traceability information including who recorded the measurement and when the inspection measurement was recorded. The measurement entry form may also include graphical display of an inspection measurement entered in measurement entry field 1538. The example graphical display of the inspection measurement is shown in graphical inspection measurement display 1532 showing an inspection measurement relative to upper and lower side specification limits. In the example graphical display 1532, the inspection measurement shows that the inspection measurement value falls outside of either a lower side limit or an upper side limit of a specification requirement for a part characteristic. This is depicted in an embodiment of FIG. 15 as an “x” shown on one side or the other of graphical display 1532 indicating which of the upper side limit or lower side limit has been exceeded by the inspection measurement.

In the present embodiment, the status notification icon/graphic for communicating status of a chosen inspection characteristic 1570 may indicate that the inspection measurement is non-conforming and an alert is necessary. The measured inspection value may be shown relative to the lower side limit and upper side limit in 1532, and in the present embodiment an “x” is used as an indicator showing that an upper side limit has been exceeded by the inspection measurement. Menu 1534 provides for an inspection method including selection of an inspection measurement gauge or machine with which to conduct the inspection. Additionally, an identification of the fabrication machine 1536 that is used in the operating step is included as part of the traceability data in the inspection measurement form 1530. This and other traceability data collected via the inspection measurement form 1530 may be used for reporting the inspection measurement data and creating a non-conformance report or non-conformance alert.

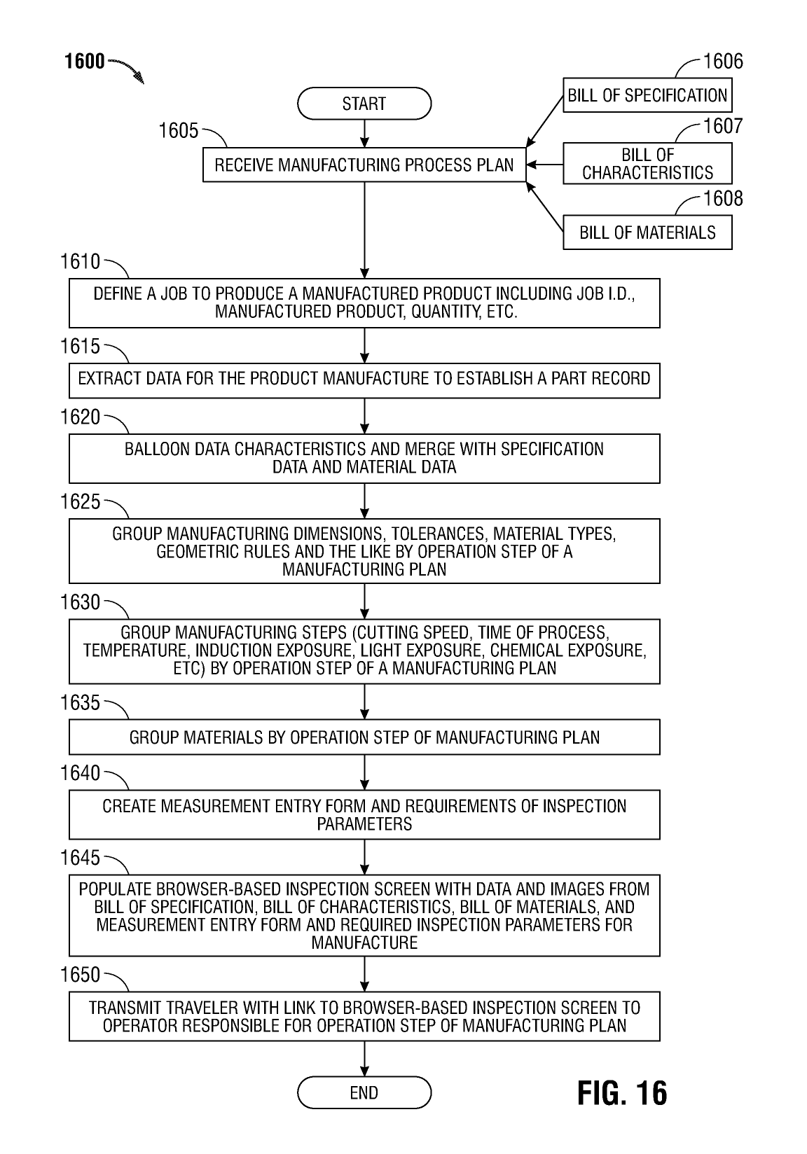

FIG. 16 shows a flow chart illustrating the exemplary method 1600 of preparing an inspection plan for manufacturing items and conducting field inspections with the browser-based inspection system according to an aspect of the present disclosure. The browser-based inspection system includes code instructions executed on one or more processors which access databases of manufacturing information, databases of received technical packages for parts to be manufactured, standards to extract relevant data, including images, for the manufacture of a part or a system comprising a plurality of parts. The extracted data is used to create an inspection plan via the browser-based inspection system according to the present disclosure. The process begins at 1605 where the browser-based inspection system receives an overall manufacturing process plan designed for the manufacturing facility or facilities at which the parts or system are to be fabricated. The manufacturing process plan may be created by industrial or process engineers in connection with customers who have designed and order manufacture of the part or system. A series of engineering requirements may be received from a customer ordering parts for manufacture. The engineering requirements for the part or system to be manufactured may be referred to as a technical data package received from a part or system designer. As used herein, a manufactured part or an inspected part may refer as well to a manufactured system or inspected system that has been manufactured and may comprise a plurality of parts or may generally refer to a plurality of manufactured parts subject to inspection. The technical data package may include a broad amount of data including dimensions, geometric requirements, tolerances, materials, material qualities, manufacturing processes to be performed, and standards to be met in manufacturing the part or system to meet specifications required for safety or other purposes. The technical data package may include a bill of specification 1606, a bill of characteristics 1607, a bill of materials 1608, and 2D or 3D product images such as blueprint CAD drawings as well as other relevant engineering requirement sources including technical standards set forth by national or international organizations such as the ASME.

The technical data package associated with a manufactured part or system is included with and associated with the manufacturing process plan created to produce the part or system within the facility or facilities. Merger between extracted data from the technical data package and other sources and the manufacturing process plan may be conducted using the integrated, browser-based inspection system of the present disclosure. The integrated, browser-based inspection system may include a series of user interfaces for establishing a manufacturing process plan with a plurality of operating steps tailored to the manufacturing facility or facilities. In other aspects, the manufacturing process plan may be created and transmitted to the integrated, browser-based inspection system of the present disclosure and stored in a memory device such as a database. Included in the determination of the manufacturing process plan may be facility scheduling, manufacturing machine capability, operator availability and other considerations. Once a manufacturing process plan for how to make the part within the manufacturing facility or facilities is created, the browser-based inspection system may be used to established an inspection plan coordinated with the manufacturing process plan as described.

Proceeding to 1610, a job is defined for production of the part. A job definition may include a job identification, a part number, a revision, a description or name of the manufactured part, a quantity to be produced, customer ordering the part, and inspection levels for the part required by the customer or engineering specification. A defined job is then associated with a manufacturing process plan created for fabrication of a part within the manufacturing facilities and subject to inspection via the browser-based inspection system of the present disclosure.

At 1615, a part record is created for the part to be made. The part record may be associated with a plurality of jobs or just with one job specified above in 1610 in some embodiments. Data is extracted from the engineering requirement data for the part relating to manufacturing and inspection requirements and specifications for the manufacturing process plan. Data extracted may include 2D or 3D CAD or other drawings of part blueprint images. Further, lists of specifications and dimensions for the part are extracted into lists relating to the inspections that will be required by the overall manufacturing process plan at operating step junctures.

At 1620, balloon callouts are assigned to portions of the 2D or 3D CAD drawings and associated with inspection characteristics extracted from engineering requirements and from the manufacturing process plan relating to fabrication machine function and the like. As described above, ballooning software that is independent of the integrated, browser-based inspection system may be used to associate ballooning with the CAD drawings of the part to be manufactured in some embodiments. The ballooned CAD drawings may be then received by the browser-based inspection system for incorporation. In other embodiments, the ballooning software may be part of the integrated, browser-based inspection system and associated indicated portions of the CAD part drawings with part characteristics of manufacturing process specification standards or engineering requirements extracted from the technical data package for a part as described above. The balloons may involve a numbering that corresponds to a list of inspection characteristics. Inspection characteristics may include physical part characteristics of portions of the part to be manufactured such as dimensions or physical properties, as well as detailed manufacturing process specification standards or requirements to be used when detailed manufacturing process steps are used in fabricating each portion of the manufactured part.

Proceeding to 1625, inspection characteristics extracted from the engineering requirements data of the technical data package for the part, such as the physical characteristics of the part extracted from a bill of characteristics, is coordinated with the plurality of operating steps in the overall manufacturing process plan for the manufacturing facility or facilities. The several operating steps may be associated with a fabrication machine or process machine or may be portioned by stations involving several fabrication machines or processes in an example embodiment. In other embodiments, operating steps may be associated with one or more operators having similar manufacturing responsibilities. The integrated, browser-based inspection system groups each of the part characteristics with the operating step responsible for the fabrication of that portion or portions of the manufactured part. Inspection data for those portions of the manufactured part are similarly grouped with the operating step to conduct fabrication of that part. As a result, a list of inspection characteristics is associated with an operating step and made available via a browser-based inspection screen for conducting inspection measurements when required.

At 1630, detailed manufacturing process specification standards or requirements to be used when fabricating each portion of the manufactured part are extracted from the engineering requirements data of the technical data package for the part. The detailed manufacturing process specification standards or engineering requirements may be extracted from a bill of specification in an example embodiment. The extracted data from the technical data package is coordinated with the plurality of operating steps in the overall manufacturing process plan for the manufacturing facility or facilities. As described above, each of the several operating steps may be associated with a fabrication machine or process machine. In other embodiments, an operating step may be associated with one or more fabrication or processing machines or may be associated with an operator responsible for particular aspects of the manufacturing activity that comprise each operating step. The integrated, browser-based inspection system groups each of the manufacturing process specification standards or requirements with the operating step responsible for the fabrication of that portion or portions of the manufactured part. Inspection data for those manufacturing process activities and portions of the manufactured part are similarly grouped with the operating step to conduct fabrication of that part. As a result, a list of manufacturing process specification standards or requirements to be used when fabricating each portion of the manufactured part is created and serve as a basis for the list of inspection characteristics along with the part characteristics grouped by operating step of the manufacturing process plan as described above in 1625.

The flow proceeds to 1635 where materials information, such as that extracted from the bill of materials for a part, is grouped by operating step of the manufacturing process plan in some example embodiments. The materials may simply be delivered or a sufficient supply made available to operators or fabrication equipment at each operating step of the manufacturing process plan in some embodiments. In other embodiments, a designation of materials and engineering specification requirements for those materials may be provided to operating steps via the browser-based inspection system of the present disclosure. An operator may have a selection of materials available.

Upon determination of the inspection characteristics associated with each of the operating steps of the manufacturing process plan for a part, flow proceeds to 1640. At 1640, the browser-based inspection system extracts data relating to tolerances, specification limits, process specification requirements, inspection machines, sensors, and frequency of required inspections to create an inspection measurement entry form. The browser-based inspection system establishes the required measurements and details of each inspection characteristic for the operating steps of an overall manufacturing process plan at 1640. With the details and measurements of each inspection characteristic established, the browser-based inspection system creates the inspection measurement form for display to gather or receive inspection measurements relating to each inspection characteristic. In some embodiments, the inspection measurement form is as described above and located or overlayed near a balloon callout for a portion of a manufactured part on the image of the part. The ballooned callout identifies a portion of the CAD or blueprint image that corresponds to an inspection characteristic of the manufactured part. In other embodiments, the inspection measurement form may be displayed in a window or in another way identifying it with an inspection characteristic requiring measurements to be taken or entered. In at least one embodiment, the measurement inspection form may accept manual entry of inspection measurements. In other embodiments, automatic measurements may be acquired from inspection or fabrication machinery and be transmitted and displayed in the inspection measurement form.

Various aspects of the measurement entry form are described and illustrated in the embodiments above. These include an indication on the inspection measurement entry forms of whether inspection measurements fall within specification requirements or fail the specification limits or requirements. In various embodiments above, a graphical representation of the inspection measurement may be shown as a value relevant to upper and lower side limit values. In another embodiment, a failed inspection measurement may trigger display of a menu for creating a non-conformance report and acquiring traceability data relating to the inspection failure including recording a reason for assignable cause and corrective action as described for embodiments above.

Proceeding to 1645, the integrated, browser-based inspection system may populate a browser-based inspection screen similar to the several examples illustrated in the figures above. The browser-based inspection screen may include a list of inspection characteristics, job identification, and some portion of the part information extracted from the received technical data package and the overall manufacturing process plan. In other embodiments, the browser-based inspection screen may be populated with a set of balloon callouts on a 2D or 3D blueprint image of the manufactured part corresponding to one or more of the inspection characteristics. Additional features, as described and shown in the above embodiments, may include an inspection measurement entry form, a status notification icon/graphic for communicating status of a chosen inspection characteristic, graphical charts for graphically illustrating inspection results including but not limited to statistical process control charts, and manufacturing instructions selectable by an operator for reviewing operating and inspection instructions for an operating step. The browser-based inspection screen is a graphical and interactive system that operates with the browser-based inspection system software or hardware code to provide guidance to fabrication operators during operating steps. The browser-based inspection system will assist an operator in the manufacture of a part to meet engineering specifications and to conduct verification that an operating step has met engineering specifications by requiring inspection measurements to be taken or determination that an engineering specification or standard has been met.

At 1650, the browser-based inspection system creates a traveler document, or job set up screen, for transmission to operators at specific stations conducting operating steps of the overall manufacturing process plan. The traveler includes a job number and description of a part to be manufactured by an operator among other manufacturing details for operating steps assigned to an operator. Other details include quantity, start dates, due dates, and similar details. An example embodiment of the job set up screen is shown in FIG. 12 and a list of job set up screens and assigned operators (“owners”) is shown in FIG. 13 above. Other variations of the traveler document are contemplated as well. The traveler document may be transmitted to an operator via a browser upon log in to a terminal by an operator or via other electronic means such as email, IM, or the like. In some embodiments, the traveler document may be a document physically delivered to an operator. The traveler provides job numbers and part identification that may be used to access the integrated, browser-based inspection screen customized for the operating step that the operator is responsible, at least in part, to complete. In an embodiment, access to a browser-based inspection screen for a part may be done by clicking a link to the same. In other embodiments, a part number, and job number or other identification number may be entered into a browser terminal to bring up a browser-based inspection screen for the operating step. At this point the process of FIG. 16 may end.

While the method of FIG. 16 is depicted in a flow chart it is understood that no sequence or order is required to be performed. Aspects of the disclosed method of FIG. 16 may be conducted in parallel or may be conducted in any order as may be appreciated. Further, method steps may be omitted or others may be added as contemplated by those of ordinary skill and the method of FIG. 16 may be combined with other embodiments as disclosed herein or steps performed as would be understood.

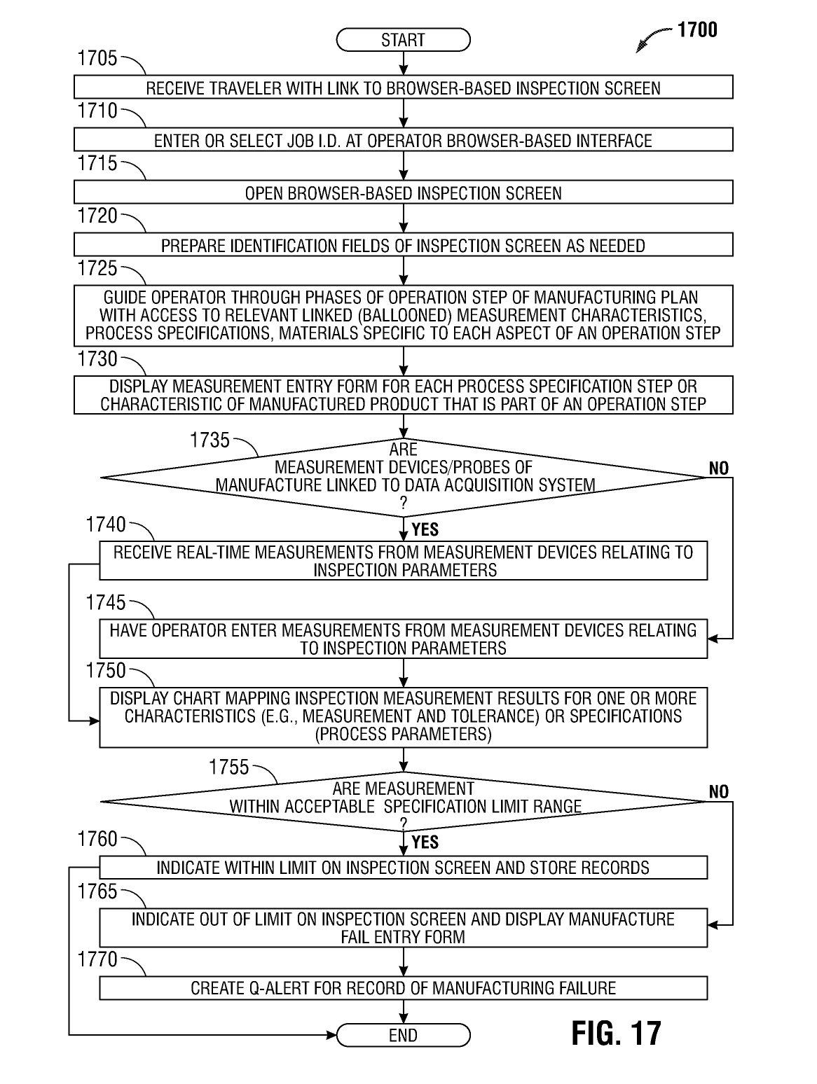

FIG. 17 shows a flow chart illustrating the exemplary method 1700 of utilizing a prepared browser-based inspection plan for manufacturing items and conducting field inspections with the browser-based inspection system according to an aspect of the present disclosure. The process begins at 1705 where an operator receives a traveler with links to jobs to be performed for assigned operating steps of one or more overall manufacturing plans for the manufacture of one or more parts. The traveler document may be electronic in some embodiments and have a link to a browser-based inspection system. For example, the traveler document may be a job setup screen as described in embodiments above. Each identified job and part to be manufactured, at least in part, by the operator may be linked in the traveler document to a browser-based inspection screen for conducting the operating step manufacturing activities and for verifying of the manufacturing activities via inspections of one or more inspection characteristics for the manufactured parts. At 1710, the operator may link to a job for an identified part to be manufactured within the integrated, browser-based inspection system in some embodiments. In other embodiments, a job identification or a part identification may be entered into a browser terminal by the operator to pull up the browser-based inspection screen to conduct the operating step manufacturing and inspection. At 1715, the browser-based inspection screen is opened for the job and part to be manufactured. The browser-based inspection screen is tailored to the operating step of an overall manufacturing process plan to be performed by an operator. In some embodiments, this may include accessing an inspection characteristics list and viewing corresponding balloon callouts on a 2D or 3D image of the part to be manufactured.

Proceeding to 1720, data fields such as identification fields of the browser-based inspection screen may need to be prepared before the operating step and the inspections commence. In one example embodiment, start time for the manufacturing activity of the operating step may be logged in. In another embodiment, start times or frequency of inspection measurements may be logged into the browser-based inspection screen. In other embodiments, selection of the machinery performing the fabrication or detailed process specification may be identified in the browser-based inspection screen. In yet other embodiments, the measurement machine to be used for the inspections may be identified. Other identification fields may also be prepared as needed and understood by those of skill based on the embodiments disclosed herein.

Proceeding to 1725, the browser-based inspection screen provides guidance to the operator for phases of the operating step that the operator is responsible for within an overall manufacturing process plan. The inspection characteristic list may include coordinates for locating a portion of a part to be manufactured on a 2D or 3D CAD image of the part. Balloon callouts may provide engineering specifications including dimension and tolerance requirements, geometric requirements, and detailed process specification requirements such as cutting speed, temperature, time, chemical exposure, etching, coating, grinding, or the like. In addition, the inspection characteristics may define the resulting manufactured part qualities after application of detailed processes during an operating step. In some embodiments, the browser-based inspection screen may provide guidance as to the materials needed to perform the operating step including detail on the material specifications, or materials for cutting, polishing, abrading tools or the like. Material specifications may also include selection of chemicals or materials to be used for chemical treatments, etching, coating or other similar detailed processes for which specification engineering requirements may be provided.

The integrated, browser-based inspection screen may further provide guidance to an operator for conducting inspection measurements at 1730. In an embodiment, display of an inspection measurement form may occur as the sequence of inspection characteristics is followed during the operating step of the overall manufacturing process plan. The inspection measurement screen provides for a type of inspection measurement and a measurement machine or gauge to be used in the inspection measurement. The browser-based inspection screen may also provide additional guidance as to engineering requirements that must be met or standards for detailed manufacturing process steps that must be met. The inspection measurement screen also provides for entry of inspection measurements in at least one field. In an aspect, graphical parameters are shown as to how that inspection measurement compares to engineering requirements such as upper and lower side limits or historic graphical trends of inspection measurements. In some embodiments, the integrated, browser-based inspection system may require some inspection measurements to be taken by an operator and entered into the inspection measurement form. In other embodiments, the integrated, browser-based inspection system may be linked to a manufacturing machine or inspection measurement machine operating during the ongoing fabrication. That manufacturing machine or inspection measurement machine may supply, via a networked connection, inspection measurements relating to one or more inspection characteristics.

At 1735, the integrated, browser-based inspection system detects whether a link to a manufacturing machine or an inspection measurement machine are available. If so, the inspection measurements are received at 1740 real-time during an operating step and stored for use with an inspection report. The received real-time inspection measurements received at 1740 may be displayed in the inspection measurement form as described herein in example embodiments of a browser-based inspection screen. If no link is available for inspection measurements from a manufacturing machine or an inspection measurement machine, the inspection may be conducted by an operator and entered into an inspection measurement form in a data entry field at 1745. Each inspection characteristic may be different and some may have networked links to the fabrication or inspection measurement machinery while other inspection characteristics require an operator to conduct inspection measurements.

Whether the inspection measurements are received via a networked link or are conducted by an operator, the flow proceeds to 1750. At 1750, the integrated, browser-based inspection system may display the inspection measurement results in a chart or table. Inspection measurements may be graphed, in some example embodiments, as the inspections are conducted as with the embodiments above showing graphical charts for graphically illustrating inspection results. One example embodiment includes statistical process control charts displaying the progress of inspection measurements. These charts illustrating inspection results may track the measured results as a series of ordered inspections conducted for a part in some embodiments. In other embodiments, the browser-based inspection system may chart inspection measurement results in a moving range relative to upper or lower control limits. An immediate inspection measurement may also be displayed relative to upper or lower control limits graphically in the inspection measurement form of the browser-based inspection system. Inspection measurement charts may also reflect whether detailed processes or the result of detailed manufacturing processes performed have met or failed standards for milling and fabrication required or engineering specifications requested by a customer. This data may appear in simple table form in an example embodiment of some detailed process specification requirements.

Flow proceeds to 1755 where the browser-based inspection system determines whether a received inspection measurement for an inspection characteristic falls within an acceptable specification limit range or passes an engineering specification requirement or standard. If so, the browser-based inspection system will proceed to 1760 to record the inspection measurement or the specification status of the inspected part and store them in a record of the inspection measurements. At this point, the process may end.

If the received inspection measurement for an inspection characteristic falls outside an acceptable specification limit range or fails an engineering specification requirement or standard, the browser-based inspection system will proceed to 1765 to provide an immediate indication that the inspection measurement has failed to meet engineering specifications or has failed a standard. This further triggers a menu to be displayed to provide for a non-conformance report to be created (a Q-alert) at 1770. The non-conformance report records the manufacturing inspection failure. The browser-base inspection system may alert manufacturing facility quality engineers or manufacturing managers of the inspection failure in some embodiments as well. The non-conformance report may require entry of additional data relating to the inspection failure. The non-conformance report may require traceability data collection for example as described in several embodiments above of the present disclosure.

At 1770, the browser-based inspection screen may provide for several indications that an inspection measurement has failed. For example, a status notification icon/graphic for communicating status of a chosen inspection characteristic may indicate that the inspection measurements entered or acquired from inspection measurements conducted during an operating step fail to meet the specified value range and that the inspection measurement is non-conforming. In other example embodiments, the measurement entry field where the inspection measurement is received and displayed may indicate a measurement is out of specification and has failed inspection. In yet another embodiment, the measured inspection value may be shown relative to the lower side limit and upper side limit and an “x” or other indicator may show which control limit an inspection measurement has fallen beyond. Several embodiments are described above.

To prepare an alert or a non-conformance report at 1770, a menu may be provided to gather traceability data for the failed inspection in the inspection measurement screen including the inspection method and measurement gauge or machine used to conduct the inspection, identification of the manufacturing machine, identification of the inspection measurement method or machine, identification of the operator, and a selection of an assignable cause of the failure. The assignable cause may be selected from one or more of the manufacturing machine, the material, operator error, the inspection measurement machine or method, material failures, or another assignable cause. The non-conformance report menu may also require comments on the failed inspection as well as comments or a description of the corrective action taken, if any. A non-conformance report is transmitted by the integrated, browser-based inspection system at 1770 to a central database and recorded for a job and part number for later review. Further, a non-conformance alert may be transmitted at 1770 to a facility manager or quality engineer or other responsive party by the integrated, browser-based inspection system.

In some embodiments, another option may occur, although not shown in FIG. 17. In an aspect, although an inspection measurement may be determined to be conforming at 1655, a trend in inspection measurements may indicate a trend or drift toward non-conformance. In an example embodiment, the trend or drift may be assessed based on statistical control limits for the operating step or a detailed manufacturing process based on previous inspection measurement data. For example, a drift may occur toward an upper or lower side control limit as the inspections progress throughout a job for a manufactured part. This drift or trend may indicate a manufacturing machine is going out of calibration, parts are wearing out, or materials are depleted, among other factors. Instead of a non-conformance alert after a bad part has already been made, the predicted non-conformance feature of an embodiment of the browser-based inspection system provides for alerting an operator before a bad part is actually made. A statistical analysis of the trending inspection measurements may also be used to predict when non-conformance may be reached. The integrated, browser-based inspection system may detect the drift or trend toward non-conformance and create a warning of predicted non-conformance to an operator and such data may be stored in a central database. Similar traceability data may be gathered to that set of traceability data gathered for a non-conformance report. Predicted non-conformance data may include selection of an assignable cause if available and a statement of corrective action taken to adjust the trending inspection measurements such as a recalibration, replenishment of material, or replacement of parts. It is understood that the indicator of predicted future non-conformance of an inspection characteristic may be distinct from an alert of non-conformance in that colors or other indicators may vary and in that a predicted non-conformance alert may not need to be transmitted to facility managers or the like in some embodiments. At this point the process of FIG. 17 may end.

While the method of FIG. 17 is depicted in a flow chart it is understood that no sequence or order is required and aspects of the disclosed method may be conducted in parallel or may be conducted in any order as may be appreciated. Further, method steps may be omitted or others may be added as contemplated by those of ordinary skill and the method of FIG. 17 may be combined with other embodiments as disclosed herein or steps performed as would be understood by those of skill in the art.

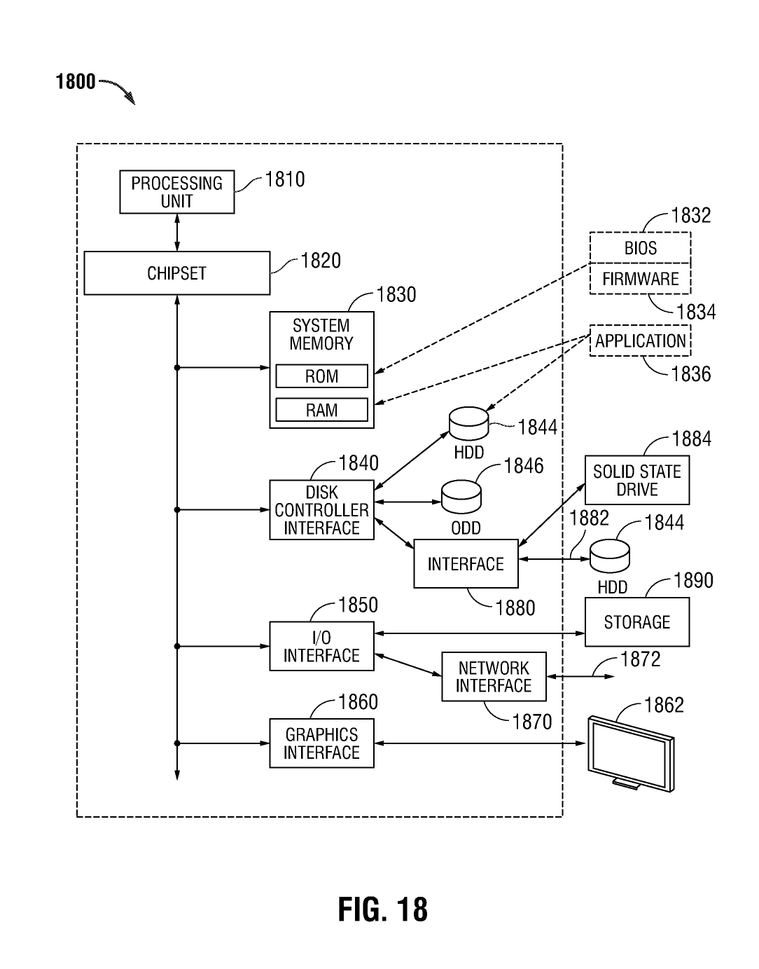

FIG. 18 is a block diagram illustrating an embodiment of a computer or server system 1800, including a processing unit 1810, a chipset 1820, a system memory 1830, a disk controller/interface 1840, an input/output (I/O) interface 1850, graphics interface 1860, and a network interface 1870. In a particular embodiment, the computer or server system 1800 is used to carry out one or more of the methods described herein. In another embodiment, one or more of the computer or server systems described herein are implemented with a storage database to host the video interactive selection system, to host the video provider website with client side code, and to carry out the methods described herein.

Chipset 1820 is connected to processing unit 1810 via a bus or other channel, allowing the processing unit to execute machine-executable code. In a particular embodiment, computer or server system 1800 may include one or more processing units. Chipset 1820 may support the multiple processing units and permit the exchange of data among the processing units and the other elements of the computer or server system. It is understood that several processing architectures may be used involving one or more processors, including multiple processor architectures as known in the art. Non-limiting examples include ARM architecture or Intel Core architecture among others. A bus or other channel permits the system to share data among the processing unit, the chipset, and other elements of computer or server system 1800.

System memory 1830 is connected to chipset 1820. System memory 1830 and chipset 1820 can be connected via a bus or other channel to share data among the chipset, the memory, and other elements of computer or server system 1800. In another embodiment, processing unit 1810 may be connected to system memory 1830. A non-limiting example of system memory 1830 includes static random access memory, dynamic random access memory, non-volatile random access memory, read only memory, flash memory, or any combination thereof.

Disk controller/interface 1840 is connected to chipset 1820. Disk controller/interface 1840 and chipset 1820 can be connected via a bus or other channel to share data among the chipset, the disk controller, and other elements of computer or server system 1800. Disk controller/interface 1840 is connected to one or more disk drives. Such disk drives may include an internal or external hard disk drive (HDD) 1844, and an optical disk drive (ODD) 1846, and can include one or more disk drives as needed or desired. ODD 1846 can include a Read/Write Compact Disk (R/W-CD), a Read/Write Digital Video Disk (R/W-DVD), a Read/Write mini Digital Video Disk (R/W mini-DVD), another type of optical disk drive, or any combination. Additionally, disk controller 1840 is connected to disk interface 1880. Disk interface 1880 permits a solid-state drive 1884 or external HDD 1844 to be coupled to a computer or server system 1800 via an external interface 1882. External interface 1882 can include industry standard busses such as a Universal Serial Bus (USB), IEEE-1394 Firewire, or other proprietary or industry-standard busses. Solid-state drive 1884 can alternatively be disposed within the computer or server system 1800. Any of the above drivers, individually or in combination, may save as the database storage for the merchant forum system. Alternatively, network links may connect to off-site memory or storage devices to save data as part of an inspection system database.

I/O interface 1850 may include an I/O controller and is connected to chipset 1820. I/O interface 1850 and chipset 1820 can be connected via a bus or other channel to share data among the chipset, the I/O interface, and other elements of computer or server system 1800. I/O interface 1850 is connected to one or more peripheral devices via possible intermediate channels and devices. Peripheral devices can include devices such as including a keyboard, mouse, or storage systems 1890, graphics interfaces, network interface devices 1870, sound/video processing units, or other peripheral devices. Network interface 1870 includes one or more network channels 1872 that provide an interface between the computer or server system 1800 and other devices that are external to computer or server system 1800 such as via internet connectivity and the like. This includes an interface between the computer or server system 1800 that may host an inspection database system and various wired and wireless networks connected to the mobile devices or computers of operators, inspection engineers, manufacturing management, and customers for executing the methods and system described herein.

Graphics interface 1860 is connected to chipset 1820 via a bus or other channel which permits exchange of data among the chipset, the graphics interface, and other elements of computer or server system 1800. Graphics interface 1860 is connected to a video display 1862.

Computer or server system 1800 includes Basic Input/Output System (BIOS) 1832 and firmware code 1834, and one or more application programs 1836. BIOS code 1832 functions initializes the computer server system 1800 on power up to launch an operating system, and to manage input and output interactions between the operating system and the other elements of the computer or server system. In a particular embodiment, the BIOS 1832 and firmware code 1834 and application programs 1836 are stored in memory 1830. The BIOS code 1832, firmware 1834, and application programs 1836 include machine-executable code that is executed by processing unit 1810 to perform various functions of computer or server system 1800. In another embodiment, the BIOS code 1832, firmware 1834, and application programs 1836 are stored in another storage medium of computer or server system 1800. The BIOS code 1832, firmware 1834, and application programs 1836 can each be implemented as single programs, or as separate programs to implement the methods and merchant forum system described herein. The machine executable code used to execute the computer implemented method steps and create the integrated manufacturing quality inspection system described herein are examples of application programs 1836 in the described embodiments.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The numerous innovative teachings of the present application will be described with particular reference to the exemplary embodiments. However, it should be understood that this class of embodiments provides only a few examples of the many advantageous uses of the innovative teachings herein. In general, statements made in the specification of the present application do not necessarily limit any of the various claimed inventions. To the contrary, the description of the exemplary embodiments are intended to cover alternative, modifications, and equivalents as may be included within the spirit and scope of the invention as defined by the claims. Moreover, some statements may apply to some inventive features but not to others.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A computer-implemented method comprising:
receive at a memory device a manufacturing process plan having a plurality of operating steps including data from a bill of specification including manufacturing process step requirements for a manufactured product and data from a bill of characteristics including dimensions and tolerances for the manufactured product;
extract data via a processor executing instructions from both the bill of specification and the bill of characteristics relating to inspection of the manufactured product;
define a job to produce the manufactured product wherein the job includes assigning an identification number, specifying the product to be manufactured, identifying the quantity to be made, and identifying the number of manufactured products to be inspected;
grouping manufacturing dimensions extracted from the bill of characteristics by operating step in manufacturing process plan;
populate a browser-based inspection screen to be viewed by an operator including inspection requirements specific to the operating step to be performed by the operator.

2. The computer-implemented method of claim 1, further comprising:
receiving a bill of material including material needed to perform the manufacturing process plan and grouping materials extracted from the bill of material by operating step in the manufacturing process plan.

3. The computer-implemented method of claim 1, further comprising:
grouping manufacturing process steps required standards extracted from the bill of specification by operating step in the manufacturing process plan.

4. The computer-implemented method of claim 3, wherein manufacturing process step requires standards parameters extracted from the bill of specification and include a time and temperature to be applied to a manufacturing treatment step in a heat treatment as an inspection requirement in the browser-based inspection screen document.

5. The computer-implemented method of claim 1, further comprising:
accessing the browser-based inspection screen by the operator to monitor inspection requirements during performance of the operating step, including receiving measurement of manufacturing dimensions and tolerances during the operating step.

6. The computer-implemented method of claim 5, wherein the browser-based inspection screen further comprises CAD images extracted from the bill of characteristics and includes ballooning data with unique identification numbers designating inspection characteristics associated with identified parts of the CAD image.

7. The computer-implemented method of claim 1, wherein the browser-based inspection screen further comprises operating step instructions specific to the operating step to be performed by the operator.

8. A browser-based graphic manufacturing inspection system comprising:
a processor identifying a manufacturing process plan having a plurality of operating steps and accessing data from a bill of specification for a manufactured product and data from a bill of characteristics for the manufactured product;
the processor extracting manufacturing dimensions and tolerances from a bill of characteristics and extracting process step required standards from the bill of specification;
the processor grouping the manufacturing dimensions and process step required standards by operating step in manufacturing process plan;
the processor populating a browser-based inspection screen to be displayed to an operator with a graphical computer aided design schematic for the manufactured product with graphical balloon links to manufacturing dimensions and tolerances and further including inspection requirements specific to the operating step to be performed by the operator,
wherein the browser-based inspection screen links a dimension highlighted with a graphical balloon on the graphical computer aided design schematic with a list of characteristics including dimensions, tolerances and geometric requirements for that dimension, and
wherein the browser-based inspection screen collects a plurality of inspection measurements for the dimension highlighted with a graphical balloon as the operating step is being performed for a plurality of the manufactured product.

9. The system of claim 8, further comprising:
the browser-based inspection screen displaying operating step instructions specific to the operating step to be performed by the operator.

10. The system of claim 8, wherein the browser-based inspection screen links the dimension highlighted with the graphical balloon on the graphical computer aided design schematic with process step required standards to be performed at the operating step for manufacturing the dimension.

11. The system of claim 10, wherein the process step required standards include a cutting speed standard to be performed during the operating step.

12. The system of claim 8, wherein each manufacturing dimension and tolerance with a balloon link is a uniquely identified balloon link.

13. The system of claim 8, further comprising:
the browser-based inspection screen receiving real time measurement data for the inspection requirements during performance of the operating step.

14. The system of claim 8, further comprising:
the browser-based inspection screen providing inspection quality report feedback to an operator in response to inspection measurements received during performance of the operating step.

15. A browser-based graphic manufacturing inspection system comprising:
a display screen for displaying a browser-based inspection screen to be viewed by an operator including inspection requirements specific to an operating step of a manufacturing process plan to be performed by the operator;
a processor identifying a job identification selected by an operator;
the processor selecting the browser-based inspection screen having grouped manufacturing dimensions extracted from a bill of characteristics for the operating step in the manufacturing process plan to be performed by the operator;
the processor receiving inspection measurements for the manufactured product at the operating step; and
the display screen displaying quality inspection indication of whether an inspected part falls within an acceptable range of specification limits in response to the inspection measurements on the browser-based inspection screen.

16. The system of claim 15, further comprising:
the display screen displaying an indication of an inspection measurement non-conforming with the acceptable range of specification limits on the browser-based inspection screen; and
the processor generating a quality alert for the detected non-conforming inspection measurement.

17. The system of claim 16, wherein the display screen displays a quality alert entry form to receive traceability data on the non-conforming measurement from the operating step of the manufacturing process plan.

18. The system of claim 17, wherein the processor generates a table of quality alerts by operating step for management of the manufacturing process plan quality.

19. The system of claim 15, further comprising:
the processor selecting the browser-based inspection screen having grouped manufacturing process step required standards extracted from a bill of specification for the operating step in the manufacturing process plan to be performed by the operator; and
the display screen displaying quality inspection indication of whether a process performed to manufacture the manufactured product falls within an acceptable range of specification limits for the process step required standards in response to the inspection measurements on the browser-based inspection screen.

20. The system of claim 15, wherein the process performed to manufacture the manufactured product is a hardening process step and the inspection measurement is a hardness measurement.
